(19) United States
(12) Patent Application Publication
(10) Pub. No.: US 2025/0111652 A1
(43) Pub. Date: Apr. 3, 2025

(54) TRAINING DATA, TRAINED MODEL, IMAGING APPARATUS, LEARNING DEVICE, METHOD OF CREATING TRAINING DATA, AND METHOD OF GENERATING TRAINED MODEL

(71) Applicant: FUJIFILM Corporation, Tokyo (JP)

(72) Inventor: Taro SAITO, Saitama (JP)

(73) Assignee: FUJIFILM Corporation, Tokyo (JP)

(21) Appl. No.: 18/893,197

(22) Filed: Sep. 23, 2024

(30) Foreign Application Priority Data
Sep. 28, 2023 (JP) 2023-168762

(51) Int. Cl. G06V 10/774; G06V 10/776; G06V 10/82

(52) U.S. Cl. CPC G06V 10/774; G06V 10/776; G06V 10/82

(57) ABSTRACT

Training data is used for machine learning of a model. The training data includes a correct answer image and an example image having a smaller bit depth than the correct answer image.

This application claims priority under 35 USC 119 from Japanese Patent Application No. 2023-168762 filed on Sep. 28, 2023, the disclosure of which is incorporated by reference herein.

### BACKGROUND

### 1. Technical Field

The present disclosure relates to training data, a trained model, an imaging apparatus, a learning device, a method of creating training data, and a method of generating a trained model.

### 2. Related Art

JP2020-109897A discloses an image transmission and reception system. In the image transmission and reception system according to JP2020-109897A, at least any of a single or plurality of transmission devices comprises a machine learning unit that performs machine learning to generate model data for generating an improved image more similar to an original image from a low bit rate encoded image obtained by encoding the original image at a low bit rate. In the image transmission and reception system according to JP2020-109897A, at least any of the single or plurality of transmission devices also comprises a transmission unit that transmits the low bit rate encoded image and the model data to an outside of the apparatus. In the image transmission and reception system according to JP2020-109897A, a reception device includes an improved image generation unit that generates the improved image of the low bit rate encoded image from the received low bit rate encoded image and the received model data.

JP2006-109499A discloses an image encoding device that encodes an image. The image encoding device according to JP2006-109499A comprises classification means for classifying a pixel constituting an image as a predetermined class in accordance with a property of the pixel, mapping coefficient storage means for storing a predetermined mapping coefficient for each class, operation means for calculating correction data obtained by correcting an attention pixel to which attention is drawn in the image by performing a predetermined operation using the attention pixel and the mapping coefficient corresponding to a class of the attention pixel, and restriction means for obtaining encoded data in which the image is encoded by restricting a level of the correction data.

In the image encoding device according to JP2006-109499A, the mapping coefficient has the following features. That is, the mapping coefficient is generated by performing learning using image data for learning. Alternatively, the mapping coefficient is obtained by performing learning such that a prediction error of a prediction result obtained by predicting the original image from the encoded data with respect to the original image is minimized. Alternatively, the mapping coefficient is obtained by performing learning such that the prediction error of the prediction result obtained by predicting the original image from the encoded data with respect to the original image is less than or equal to a predetermined value. Alternatively, the mapping coefficient is a predetermined coefficient having an optimal value obtained by repeating classifying a pixel constituting an image for learning as any class corresponding to a property of the pixel, calculating correction data for learning obtained by correcting an attention pixel for learning to which attention is drawn in the image for learning by performing a predetermined operation using the attention pixel for learning and a predetermined coefficient corresponding to a class of the attention pixel for learning, obtaining restriction data for learning in which a level of the correction data for learning is restricted, predicting a prediction value of the image for learning based on the restriction data for learning, calculating a prediction error of the prediction value of the image for learning with respect to the image for learning, and changing the predetermined coefficient based on the prediction error, until the predetermined coefficient has the optimal value. Alternatively, the mapping coefficient is obtained using suitable correction data for learning and an image for learning by repeating compressing the image for learning by reducing the number of pixels of the image for learning, restricting a level of compressed data for learning obtained by compressing the image for learning, outputting correction data for learning by correcting the compressed data for learning having the restricted level, outputting a prediction value by predicting the image for learning based on the correction data for learning, calculating a prediction error of the prediction value of the image for learning with respect to the image for learning, and determining whether or not the correction data for learning is suitable based on the prediction error, until the suitable correction data for learning is obtained.

### SUMMARY

An embodiment according to the present disclosure provides training data, a trained model, an imaging apparatus, a learning device, a method of creating training data, and a method of generating a trained model that can cause a trained model to generate an image having a larger bit depth than an input image.

According to a first aspect of the present disclosure, there is provided training data used for machine learning of a model, the training data comprising a correct answer image, and an example image having a smaller bit depth than the correct answer image.

According to a second aspect of the present disclosure, in the training data according to the first aspect, the correct answer image is an image obtained by combining a plurality of single images.

According to a third aspect of the present disclosure, in the training data according to the second aspect, the example image is a representative image of the plurality of single images.

According to a fourth aspect of the present disclosure, in the training data according to the second aspect, the example image is an image having a smaller bit depth than the plurality of single images.

According to a fifth aspect of the present disclosure, in the training data according to any one of the first to fourth aspects, the single images are images subjected to bit shifting.

According to a sixth aspect of the present disclosure, in the training data according to the first aspect, the correct answer image is an image obtained by combining a processing target region in an image subjected to bit shifting with a corresponding region in which an arrangement pattern in the image corresponds to the processing target region, in a case where the corresponding region is present in the image, or an image obtained by combining a processing target pixel in an image subjected to bit shifting with an adjacent pixel that has the same color as the processing target pixel and that is regularly adjacent to the processing target pixel, in a case where the adjacent pixel is present in the image.

According to a seventh aspect of the present disclosure, in the training data according to the sixth aspect, the example image is an image before bit shifting or an image generated based on an image before bit shifting.

According to an eighth aspect of the present disclosure, in the training data according to any one of the first to seventh aspects, the correct answer image and the example image are images obtained by performing imaging via a first imaging apparatus.

According to a ninth aspect of the present disclosure, in the training data according to any one of the first to eighth aspects, the correct answer image and the example image are images of a RAW format.

According to a tenth aspect of the present disclosure, in the training data according to any one of the first to eighth aspects, the model takes input of an image of a RAW format and outputs an image of the RAW format, a format of the correct answer image is a Log format, and the model is optimized by converting the image of the RAW format output from the model into an image of the Log format and comparing the image of the Log format with the correct answer image.

According to an eleventh aspect of the present disclosure, in the training data according to any one of the first to eighth aspects, the model outputs an image of a second file format other than a RAW format with respect to input of an image of a first file format other than the RAW format, a format of the example image is the first file format, and a format of the correct answer image is the second file format.

According to a twelfth aspect of the present disclosure, in the training data according to any one of the first to eleventh aspects, the example image is divided into a plurality of first image regions, and the correct answer image is divided into a plurality of second image regions corresponding to the plurality of first image regions.

According to a thirteenth aspect of the present disclosure, in the training data according to the twelfth aspect, a label with which image quality is specifiable is assigned to the plurality of second image regions.

According to a fourteenth aspect of the present disclosure, in the training data according to the twelfth or thirteenth aspect, the example image is an image assuming an image obtained by performing imaging via a second imaging apparatus, and the image quality is determined by a characteristic of the second imaging apparatus.

According to a fifteenth aspect of the present disclosure, in the training data according to the fourteenth aspect, the second imaging apparatus includes an optical system, and the characteristic includes an image height related to the optical system.

According to a sixteenth aspect of the present disclosure, there is provided trained model obtained by optimizing the model by performing the machine learning on the model using the training data according to any one of the first to fifteenth aspects.

According to a seventeenth aspect of the present disclosure, there is provided an imaging apparatus comprising a first processor, and an image sensor, in which the first processor is configured to input a captured image obtained by performing imaging via the image sensor into the trained model according to the sixteenth aspect, and acquire an inference result output from the trained model in accordance with input of the captured image.

According to an eighteenth aspect of the present disclosure, there is provided a learning device comprising a second processor, in which the second processor is configured to optimize the model by performing the machine learning on the model using the training data according to any one of the first to fifteenth aspects.

According to a nineteenth aspect of the present disclosure, there is provided a method of creating training data used for machine learning of a model, the training data including a correct answer image and an example image, the method comprising creating the correct answer image, and creating the example image having a smaller bit depth than the correct answer image.

According to a twentieth aspect of the present disclosure, there is provided a method of generating a trained model that is generated by performing machine learning on a model using training data including a correct answer image and an example image, the example image being an image having a smaller bit depth than the correct answer image, the method comprising inputting the example image into the model, outputting an evaluation target image in accordance with input of the example image via the model, and optimizing the model based on a comparison result between the evaluation target image and the correct answer image.

### BRIEF DESCRIPTION OF THE DRAWINGS

Exemplary embodiments of the technology of the disclosure will be described in detail based on the following figures, wherein:

FIG. 1 is a schematic configuration diagram illustrating an example of an overall configuration of an imaging apparatus;

FIG. 2 is a schematic configuration diagram illustrating an example of hardware configurations of an optical system and an electrical system of the imaging apparatus;

FIG. 3 is a schematic diagram illustrating an example of content of a RAW image obtained by performing imaging via the imaging apparatus;

FIG. 4 is a schematic configuration diagram illustrating an example of a configuration of a learning device;

FIG. 5 is a conceptual diagram illustrating an example of a method of creating training data;

FIG. 6 is a block diagram illustrating an example of a function of an image processing engine;

FIG. 7 is a flowchart illustrating an example of a flow of learning processing performed by the learning device;

FIG. 8 is a flowchart illustrating an example of a flow of image quality enhancement processing performed by the imaging apparatus;

FIG. 9 is a conceptual diagram illustrating a first modification example of the method of creating the training data;

FIG. 10 is a conceptual diagram illustrating a second modification example of the method of creating the training data;

FIG. 11 is a conceptual diagram illustrating a third modification example of the method of creating the training data;

FIG. 12 is a conceptual diagram illustrating a fourth modification example of the method of creating the training data;

FIG. 13 is a conceptual diagram illustrating a fifth modification example of the method of creating the training data;

FIG. 14 is a conceptual diagram illustrating a first modification example of the training data;

FIG. 15 is a conceptual diagram illustrating a first modification example of the image quality enhancement processing;

FIG. 16 is a conceptual diagram illustrating a second modification example of the training data;

FIG. 17 is a conceptual diagram illustrating a third modification example of the training data;

FIG. 18 is a conceptual diagram illustrating a second modification example of the image quality enhancement processing;

FIG. 19 is a conceptual diagram illustrating a fourth modification example of the training data;

FIG. 20 is a conceptual diagram illustrating a third modification example of the image quality enhancement processing;

FIG. 21 is a conceptual diagram illustrating a fifth modification example of the training data; and

FIG. 22 is a conceptual diagram illustrating a fourth modification example of the image quality enhancement processing.

### DETAILED DESCRIPTION

Hereinafter, an example of embodiments of training data, a trained model, an imaging apparatus, a learning device, a method of creating training data, and a method of generating a trained model according to the present disclosure will be described with reference to the accompanying drawings.

First, terms used in the following description will be described.

CPU refers to the abbreviation for “Central Processing Unit”. GPU refers to the abbreviation for “Graphics Processing Unit”. GPGPU refers to the abbreviation for “General-Purpose computing on Graphics Processing Units”. APU refers to the abbreviation for “Accelerated Processing Unit”. TPU refers to the abbreviation for “Tensor Processing Unit”. NVM refers to the abbreviation for “Non-Volatile Memory”. RAM refers to the abbreviation for “Random Access Memory”. IC refers to the abbreviation for “Integrated Circuit”. ASIC refers to the abbreviation for “Application Specific Integrated Circuit”. PLD refers to the abbreviation for “Programmable Logic Device”. FPGA refers to the abbreviation for “Field-Programmable Gate Array”. SoC refers to the abbreviation for “System-on-a-Chip”. SSD refers to the abbreviation for “Solid State Drive”. USB refers to the abbreviation for “Universal Serial Bus”. HDD refers to the abbreviation for “Hard Disk Drive”. EEPROM refers to the abbreviation for “Electrically Erasable and Programmable Read Only Memory”. EL refers to the abbreviation for “Electro-Luminescence”. I/F refers to the abbreviation for “Interface”. UI refers to the abbreviation for “User Interface”. fps refers to the abbreviation for “frame per second”. MF refers to the abbreviation for “Manual Focus”. AF refers to the abbreviation for “Auto Focus”. CMOS refers to the abbreviation for “Complementary Metal Oxide Semiconductor”. CCD refers to the abbreviation for “Charge Coupled Device”. AI refers to the abbreviation for “Artificial Intelligence”. A/D refers to the abbreviation for “Analog/Digital”. FIR refers to the abbreviation for “Finite Impulse Response”. IIR refers to the abbreviation for “Infinite Impulse Response”. JPEG refers to the abbreviation for “Joint Photographic Experts Group”. TIFF refers to the abbreviation for “Tagged Image File Format”. JPEG XR refers to the abbreviation for “Joint Photographic Experts Group Extended Range”. MPEG refers to the abbreviation for “Moving Picture Expert Group”. AVI refers to the abbreviation for “Audio Video Interleaved”.

In the following description, a processor with a reference numeral (hereinafter, simply referred to as the “processor”) may be one physical or virtual operation device or a combination of a plurality of physical or virtual operation devices. The processor may be one type of operation device or a combination of a plurality of types of operation devices. Examples of the operation device include a CPU, a GPU, a GPGPU, an APU, or a TPU.

In the following description, a memory with a reference numeral is a memory such as a RAM temporarily storing information and is used as a work memory by the processor.

In the following description, a storage with a reference numeral is one or a plurality of non-volatile storage devices storing various programs and various parameters or the like. Examples of the non-volatile storage device include a flash memory, a magnetic disk, or a magnetic tape. Other examples of the storage include a cloud storage.

In the following embodiment, an external I/F with a reference numeral controls exchange of various types of information among a plurality of apparatuses connected to each other. Examples of the external I/F include a USB interface. A communication I/F including a communication processor and an antenna or the like may be applied to the external I/F. The communication I/F controls communication among a plurality of computers. Examples of a communication standard applied to the communication I/F include a wireless communication standard including 5G, Wi-Fi (registered trademark), or Bluetooth (registered trademark).

In the following embodiment, “A and/or B” is synonymous with “at least one of A or B”. That is, “A and/or B” may mean only A, only B, or a combination of A and B. In the present specification, the same approach as “A and/or B” also applies to an expression of three or more matters connected with “and/or”.

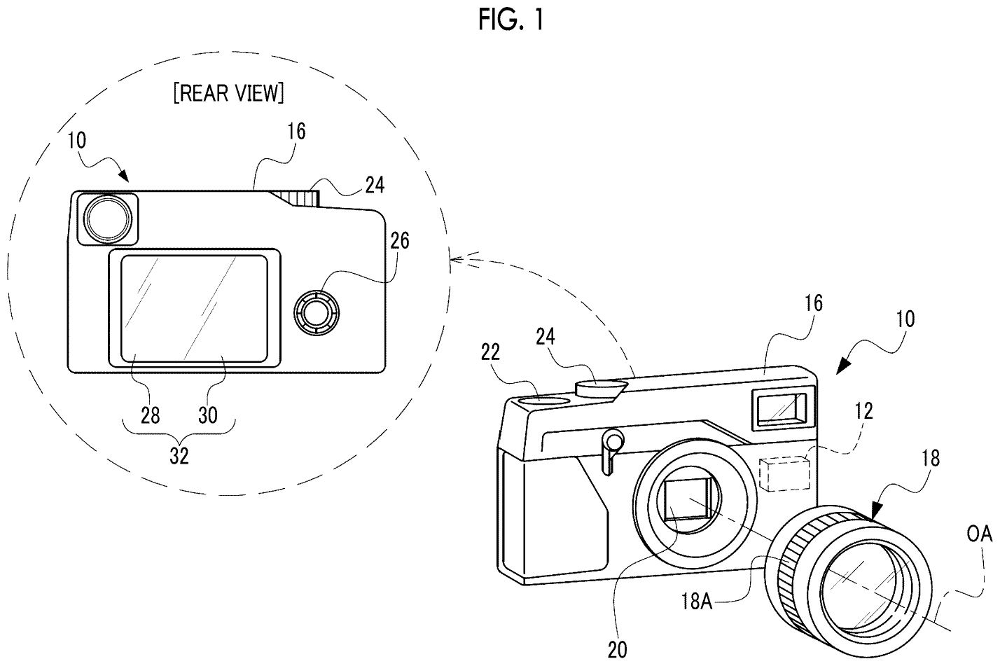

FIG. 1 is a schematic configuration diagram illustrating an example of an overall configuration of an imaging apparatus. As illustrated in FIG. 1, the imaging apparatus 10 is an apparatus that images a subject, and comprises an image processing engine 12, an imaging apparatus body 16, and an interchangeable lens 18. The imaging apparatus 10 is an example of an “imaging apparatus” and a “second imaging apparatus” according to the present disclosure.

The image processing engine 12 is incorporated in the imaging apparatus body 16 and controls the entire imaging apparatus 10. The interchangeable lens 18 is interchangeably mounted on the imaging apparatus body 16. The interchangeable lens 18 is provided with a focus ring 18A. The focus ring 18A is operated by a user or the like in a case where the user or the like (hereinafter, simply referred to as the “user”) of the imaging apparatus 10 manually adjusts focus of the imaging apparatus 10 on the subject.

In the example illustrated in FIG. 1, a lens-interchangeable digital camera is illustrated as an example of the imaging apparatus 10. However, this is merely an example. The imaging apparatus 10 may be a lens-fixed digital camera or a digital camera incorporated in various electronic apparatuses such as a smart device, a wearable terminal, an endoscope apparatus, a cell observation apparatus, an ophthalmic observation apparatus, or a surgical microscope.

The imaging apparatus body 16 is provided with an image sensor 20. The image sensor 20 is an example of an “image sensor” according to the present disclosure. The image sensor 20 is a CMOS image sensor. The image sensor 20 images an imaging range including at least one subject. In a case where the interchangeable lens 18 is mounted on the imaging apparatus body 16, an image of subject light indicating the subject is formed on the image sensor 20 through the interchangeable lens 18, and image data indicating an image of the subject is generated by the image sensor 20.

While a CMOS image sensor is illustrated as the image sensor 20 in the present embodiment, the present disclosure is not limited to this. For example, the present disclosure is also established in a case where the image sensor 20 is other types of image sensors such as a CCD image sensor.

A release button 22 and a dial 24 are provided on an upper surface of the imaging apparatus body 16. The dial 24 is operated in setting an operation mode of an imaging system, an operation mode of a playback system, and the like. An imaging mode, a playback mode, and a setting mode are selectively set in the imaging apparatus 10 as an operation mode by operating the dial 24. The imaging mode is an operation mode for performing imaging via the imaging apparatus 10. The playback mode is an operation mode for playing back an image (for example, a static image and/or a video) obtained by performing imaging for recording in the imaging mode. The setting mode is an operation mode for setting the imaging apparatus 10 in, for example, setting various set values used for a control related to imaging.

The release button 22 functions as an imaging preparation instruction unit and an imaging instruction unit, and a push operation of two phases of an imaging preparation instruction state and an imaging instruction state can be detected. For example, the imaging preparation instruction state refers to a state of pushing to an intermediate position (half push position) from a standby position, and the imaging instruction state refers to a state of pushing to a final push position (full push position) beyond the intermediate position.

Hereinafter, the “state of pushing to the half push position from the standby position” will be referred to as a “half push state”, and the “state of pushing to the full push position from the standby position” will be referred to as a “full push state”. Depending on a configuration of the imaging apparatus 10, the imaging preparation instruction state may be a state where a finger of the user is in contact with the release button 22, and the imaging instruction state may be a state after a transition from a state where the finger of the user performing an operation is in contact with the release button 22 to a state where the finger of the user is separated from the release button 22.

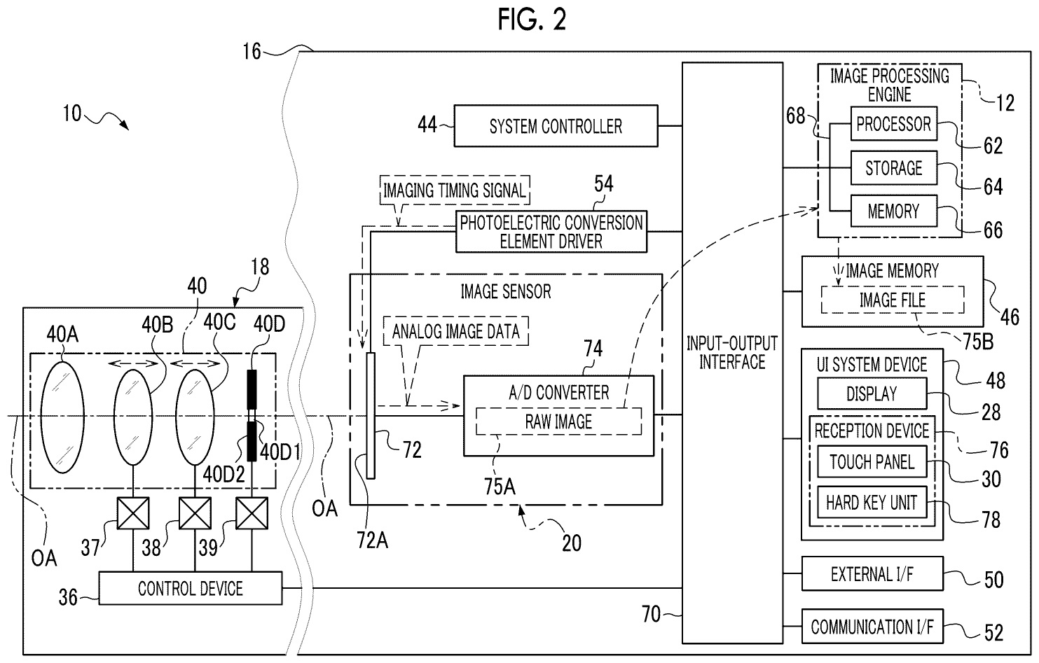

An instruction key 26 and a touch panel display 32 are provided on a rear surface of the imaging apparatus body 16. The touch panel display 32 comprises a display 28 and a touch panel 30 (refer to FIG. 2). Examples of the display 28 include an EL display (for example, an organic EL display or an inorganic EL display). The display 28 may be other types of displays such as a liquid crystal display instead of an EL display.

The display 28 displays an image and/or text information or the like. The display 28 is used for imaging for a live view image, that is, displaying a live view image obtained by performing continuous imaging, in a case where the imaging apparatus 10 is in the imaging mode. The “live view image” refers to a video for display based on the image data obtained by performing imaging via the image sensor 20. For example, the imaging for obtaining the live view image (hereinafter, referred to as “imaging for the live view image”) is performed at a frame rate of 60 fps. 60 fps is merely an example. A frame rate less than 60 fps or a frame rate exceeding 60 fps may be used.

The display 28 is also used for displaying a static image obtained by performing imaging for a static image in a case where an instruction to perform the imaging for the static image is provided to the imaging apparatus 10 through the release button 22. The display 28 is also used for displaying a playback image or the like in a case where the imaging apparatus 10 is in the playback mode. The display 28 is also used for displaying a menu screen on which various menus can be selected, and displaying a setting screen for setting various set values or the like used for the control related to imaging in a case where the imaging apparatus 10 is in the setting mode.

The touch panel 30 is a transmissive touch panel and is overlaid on a surface of a display region of the display 28. The touch panel 30 receives an instruction from the user by detecting a contact of a finger or an indicator such as a stylus pen. Hereinafter, for convenience of description, the above “full push state” will also include a state where the user turns a softkey for starting imaging on through the touch panel 30.

While an out-cell touch panel display in which the touch panel 30 is overlaid on the surface of the display region of the display 28 is illustrated as an example of the touch panel display 32 in the present embodiment, this is merely an example. For example, an on-cell or in-cell touch panel display can also be applied as the touch panel display 32.

The instruction key 26 receives various instructions. For example, the “various instructions” refer to an instruction to display the menu screen, an instruction to select one or a plurality of menus, an instruction to confirm selected content, an instruction to cancel the selected content, and various instructions such as zoom-in, zoom-out, and frame advance. These instructions may also be provided using the touch panel 30.

FIG. 2 is a schematic configuration diagram illustrating an example of hardware configurations of an optical system and an electrical system of the imaging apparatus. As illustrated in FIG. 2, the image sensor 20 comprises a photoelectric conversion element 72. The photoelectric conversion element 72 has a light-receiving surface 72A. The photoelectric conversion element 72 is disposed in the imaging apparatus body 16 such that a center of the light-receiving surface 72A matches an optical axis OA (refer to FIG. 1). The photoelectric conversion element 72 has a plurality of photosensitive pixels disposed in a matrix, and the light-receiving surface 72A is formed by the plurality of photosensitive pixels. Each photosensitive pixel includes a microlens (not illustrated). Each photosensitive pixel is a physical pixel including a photodiode (not illustrated), photoelectrically converts received light, and outputs an electrical signal corresponding to a quantity of the received light.

In the plurality of photosensitive pixels, color filters (not illustrated) of three primary colors of light, that is, red (hereinafter, referred to as “R”), green (hereinafter, referred to as “G”), or blue (hereinafter, referred to as “B”), are disposed in a predetermined pattern arrangement. In the present embodiment, a Bayer arrangement is used as an example of the predetermined pattern arrangement. However, the Bayer arrangement is merely an example. The present disclosure is also established in a case where the predetermined pattern arrangement is other types of pattern arrangements such as a G stripe R/G full checkered arrangement, an X-Trans (registered trademark) arrangement, or a honeycomb arrangement.

Hereinafter, for convenience of description, a photosensitive pixel including a microlens and a color filter of R will be referred to as an R pixel, a photosensitive pixel including a microlens and a color filter of G will be referred to as a G pixel, and a photosensitive pixel including a microlens and a color filter of B will be referred to as a B pixel. Hereinafter, for convenience of description, an electrical signal output from the R pixel of the photosensitive pixel will be referred to as an “R signal”, an electrical signal output from the G pixel of the photosensitive pixel will be referred to as a “G signal”, and an electrical signal output from the B pixel of the photosensitive pixel will be referred to as a “B signal”. Hereinafter, for convenience of description, the R signal, the G signal, and the B signal will be referred to as “color signals of RGB”. Hereinafter, for convenience of description, a pixel of R, a pixel of G, and a pixel of B constituting a RAW image 75A generated based on the color signals of RGB will also be referred to as the “R pixel”, the “G pixel”, and the “B pixel”. While the R pixel, the G pixel, and the B pixel are illustrated, this is merely an example. In a case where colors other than R, G, and B (that is, colors other than the primary colors) are also regularly disposed in the color filters together with R, G, and B, the RAW image also includes pixels of colors other than the R pixel, the G pixel, and the B pixel, and the present disclosure is also established in this case.

The interchangeable lens 18 comprises an imaging lens 40. The imaging lens 40 includes an objective lens 40A, a focus lens 40B, a zoom lens 40C, and a stop 40D. The objective lens 40A, the focus lens 40B, the zoom lens 40C, and the stop 40D are disposed in an order of the objective lens 40A, the focus lens 40B, the zoom lens 40C, and the stop 40D along the optical axis OA from a subject side (object side) to a side closer to the imaging apparatus body 16 (image side).

The interchangeable lens 18 also comprises a control device 36, a first actuator 37, a second actuator 38, and a third actuator 39. The control device 36 controls the entire interchangeable lens 18 in accordance with an instruction from the imaging apparatus body 16. For example, the control device 36 is a device including a computer including a processor, a storage, and a memory. For example, the storage of the control device 36 is an EEPROM. The storage of the control device 36 stores various programs and various parameters. For example, the memory of the control device 36 is a RAM, temporarily stores various types of information, and is used as a work memory. In the control device 36, the processor controls the entire imaging lens 40 by reading out a necessary program from the storage and executing read various programs on the memory.

While a device including a computer is illustrated as an example of the control device 36, this is merely an example. A device including an ASIC, an FPGA, and/or a PLD may be applied. For example, a device implemented by a combination of a hardware configuration and a software configuration may also be used as the control device 36.

The first actuator 37 comprises a slide mechanism for focus (not illustrated) and a motor for focus (not illustrated). The focus lens 40B is attached to the slide mechanism for focus in a slidable manner along the optical axis OA. The motor for focus is connected to the slide mechanism for focus. The slide mechanism for focus operates by receiving motive power of the motor for focus and moves the focus lens 40B along the optical axis OA.

The second actuator 38 comprises a slide mechanism for zoom (not illustrated) and a motor for zoom (not illustrated). The zoom lens 40C is attached to the slide mechanism for zoom in a slidable manner along the optical axis OA. The motor for zoom is connected to the slide mechanism for zoom. The slide mechanism for zoom operates by receiving motive power of the motor for zoom and moves the zoom lens 40C along the optical axis OA.

The third actuator 39 comprises a motive power transmission mechanism (not illustrated) and a motor for the stop (not illustrated). The stop 40D has an opening 40D1 and is a stop in which a size of the opening 40D1 is variable. For example, the opening 40D1 is formed by a plurality of stop leaf blades 40D2. The plurality of stop leaf blades 40D2 are connected to the motive power transmission mechanism. The motor for the stop is connected to the motive power transmission mechanism. The motive power transmission mechanism transmits motive power of the motor for the stop to the plurality of stop leaf blades 40D2. The plurality of stop leaf blades 40D2 operate by receiving the motive power transmitted from the motive power transmission mechanism and change the size of the opening 40D1. Exposure of the stop 40D is adjusted by changing the size of the opening 40D1.

The motor for focus, the motor for zoom, and the motor for the stop are connected to the control device 36, and driving of each of the motor for focus, the motor for zoom, and the motor for the stop is controlled by the control device 36. In the present embodiment, stepping motors are employed as examples of the motor for focus, the motor for zoom, and the motor for the stop. Accordingly, the motor for focus, the motor for zoom, and the motor for the stop operate by synchronizing with a pulse signal in accordance with an instruction from the control device 36. While an example in which the interchangeable lens 18 is provided with the motor for focus, the motor for zoom, and the motor for the stop is illustrated, this is merely an example. The imaging apparatus body 16 may be provided with at least one of the motor for focus, the motor for zoom, or the motor for the stop. Constituents and/or an operation method of the interchangeable lens 18 can be changed, as necessary.

In the imaging apparatus 10, in the imaging mode, an MF mode and an AF mode are selectively set in accordance with an instruction provided to the imaging apparatus body 16. The MF mode is an operation mode for manual focusing. In the MF mode, for example, the focus is adjusted by causing the user to operate the focus ring 18A or the like to move the focus lens 40B along the optical axis OA by a movement amount corresponding to an operation amount of the focus ring 18A or the like.

In the AF mode, the focus is adjusted by causing the imaging apparatus body 16 to perform an operation for a focusing position corresponding to a subject distance and move the focus lens 40B to the focusing position obtained by the operation. The focusing position refers to a position of the focus lens 40B on the optical axis OA in an in-focus state.

The imaging apparatus body 16 comprises the image sensor 20, the image processing engine 12, a system controller 44, an image memory 46, a UI system device 48, an external I/F 50, a communication I/F 52, a photoelectric conversion element driver 54, and an input-output interface 70. The image sensor 20 comprises the photoelectric conversion clement 72 and an A/D converter 74.

The image processing engine 12, the image memory 46, the UI system device 48, the external I/F 50, the photoelectric conversion element driver 54, a mechanical shutter driver (not illustrated), and the A/D converter 74 are connected to the input-output interface 70. The control device 36 of the interchangeable lens 18 is also connected to the input-output interface 70.

The system controller 44 comprises a processor (not illustrated), a storage (not illustrated), and a memory (not illustrated). In the system controller 44, the storage is a computer-readable non-transitory storage medium and stores various parameters and various programs. For example, the storage of the system controller 44 is an EEPROM. However, this is merely an example. An HDD and/or an SSD or the like may be applied as the storage of the system controller 44 instead of an EEPROM or together with an EEPROM. The memory of the system controller 44 temporarily stores various types of information and is used as a work memory. In the system controller 44, the processor controls the entire imaging apparatus 10 by reading out a necessary program from the storage and executing read various programs on the memory. That is, in the example illustrated in FIG. 2, the image processing engine 12, the image memory 46, the UI system device 48, the external I/F 50, the communication I/F 52, the photoelectric conversion element driver 54, and the control device 36 are controlled by the system controller 44.

The image processing engine 12 operates under control of the system controller 44. The image processing engine 12 comprises a processor 62, a storage 64, and a memory 66. The processor 62 is an example of a “first processor” according to the present disclosure.

The processor 62, the storage 64, and the memory 66 are connected to each other through a bus 68, and the bus 68 is connected to the input-output interface 70. While one bus is illustrated in the example illustrated in FIG. 2 as the bus 68 for convenience of illustration, a plurality of buses may be used. The bus 68 may be a serial bus or a parallel bus including a data bus, an address bus, a control bus, and the like.

The storage 64 is a computer-readable non-transitory storage medium and stores various parameters and various programs different from the various parameters and the various programs stored in the storage of the system controller 44. For example, the storage 64 is an EEPROM. However, this is merely an example. An HDD and/or an SSD or the like may be applied as the storage 64 instead of an EEPROM or together with an EEPROM. For example, the memory 66 is a RAM, temporarily stores various types of information, and is used as a work memory.

The processor 62 reads out a necessary program from the storage 64 and executes the read program in the memory 66. The processor 62 performs image processing in accordance with the program executed on the memory 66.

The photoelectric conversion element driver 54 is connected to the photoelectric conversion element 72. The photoelectric conversion element driver 54 supplies an imaging timing signal defining a timing of imaging performed by the photoelectric conversion element 72 to the photoelectric conversion element 72 in accordance with an instruction from the processor 62. The photoelectric conversion element 72 performs a reset, exposure, and output of an electrical signal in accordance with the imaging timing signal supplied from the photoelectric conversion element driver 54. Examples of the imaging timing signal include a vertical synchronization signal and a horizontal synchronization signal.

In a case where the interchangeable lens 18 is mounted on the imaging apparatus body 16, the image of the subject light incident on the imaging lens 40 is formed on the light-receiving surface 72A by the imaging lens 40. Under control of the photoelectric conversion element driver 54, the photoelectric conversion element 72 photoelectrically converts the subject light received by the light-receiving surface 72A and outputs an electrical signal corresponding to a light quantity of the subject light to the A/D converter 74 as analog image data indicating the subject light. Specifically, the A/D converter 74 reads out the analog image data from the photoelectric conversion clement 72 in frame units for each horizontal line using an exposure and sequential readout method.

The A/D converter 74 generates the RAW image 75A by converting the analog image data into a digital form. The RAW image 75A is an image in which R pixels, G pixels, and B pixels are arranged in a mosaic. The RAW image 75A is an example of a “captured image” according to the present disclosure.

In the present embodiment, for example, bit depths of the R pixels, the B pixels, and the G pixels included in the RAW image 75A, that is, the number of bits (in other words, a bit length, the number of color bits, or a color depth) that is a value representing a gradation of each pixel including the R pixels, the B pixels, and the G pixels included in the RAW image 75A, are 14 bits. 14 bits are merely an example. The bit depths of the R pixels, the B pixels, and the G pixels included in the RAW image 75A may exceed 14 bits or be less than 14 bits.

In the present embodiment, for example, the processor 62 of the image processing engine 12 acquires the RAW image 75A from the A/D converter 74 and generates an image file 75B by performing the image processing including development on the acquired RAW image 75A. The development refers to processing of compressing a brightness color difference signal in accordance with a predetermined compression method. Examples of the predetermined compression method (that is, a format of the image file) include JPEG, TIFF, JPEG XR, MPEG, or AVI. The image processing includes image quality adjustment of the RAW image 75A. The image quality adjustment of the RAW image 75A is implemented by focal length adjustment, F number adjustment, lens characteristic adjustment, thinning-out characteristic adjustment between pixels P, a gradation correction function (for example, processing of correcting a gradation of an RGB image in accordance with a gamma value), a gain correction function, a noise reducing function, and the like.

Other examples of the image quality adjustment of the RAW image 75A include color space conversion processing (that is, processing of converting a color space of an RGB image on which gamma correction processing is performed from an RGB color space to a YCbCr color space), brightness filter processing (that is, processing of filtering a brightness signal (so-called Y signal) using a brightness filter (not illustrated)), color difference processing (that is, processing of performing filtering of reducing high-frequency noise in a Cb signal and a Cr signal), and/or resize processing (that is, processing of adjusting the brightness color difference signal such that a size of an image indicated by the brightness color difference signal matches a size provided by an instruction of the user or the like).

Examples of the image file 75B include an MPEG file. The MPEG file is merely an example. The image file 75B may be other types of image files such as a JPEG file, a JPEG XR file, a TIFF file, or an AVI file. The image file 75B is stored in the image memory 46 by the processor 62.

The UI system device 48 comprises the display 28, and the processor 62 displays various types of information on the display 28. The UI system device 48 also comprises a reception device 76. The reception device 76 comprises the touch panel 30 and a hard key unit 78. The hard key unit 78 includes a plurality of hard keys including the instruction key 26 (refer to FIG. 1). The processor 62 operates in accordance with various instructions received by the touch panel 30. While the hard key unit 78 is included in the UI system device 48, the present disclosure is not limited to this. For example, the hard key unit 78 may be connected to the external I/F 50.

The external I/F 50 controls exchange of various types of information with an apparatus present outside the imaging apparatus 10 (hereinafter, referred to as an “external apparatus”). Examples of the external I/F 50 include a USB interface. The external apparatus (not illustrated) such as a smart device, a personal computer, a server, a USB memory, a memory card, and/or a printer is directly or indirectly connected to the USB interface.

The communication I/F 52 is connected to a network (not illustrated). The communication I/F 52 controls exchange of information between a communication device (not illustrated) such as a server on the network and the system controller 44. For example, the communication I/F 52 transmits information corresponding to a request from the system controller 44 to the communication device through the network. The communication I/F 52 receives information transmitted from the communication device and outputs the received information to the system controller 44 through the input-output interface 70.

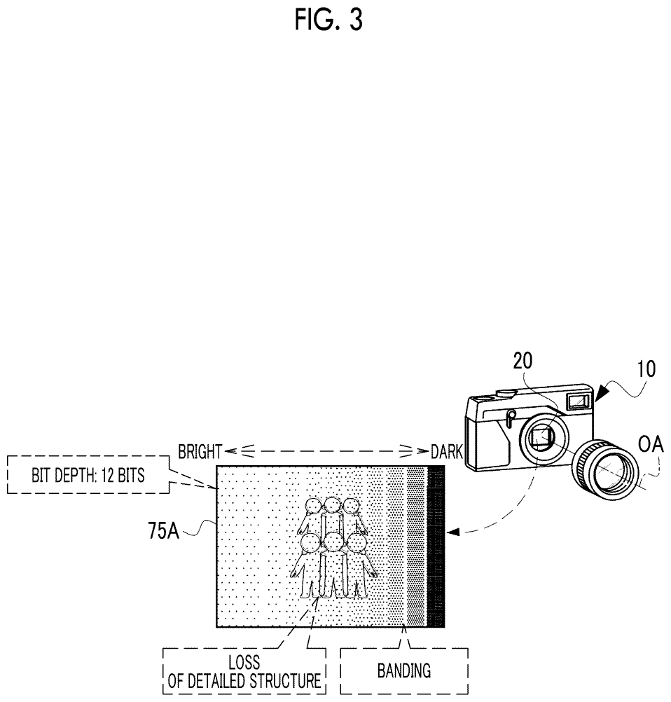

In editing a video used in a movie, a television, or the like, a dynamic range is widely known as one of particularly important specifications. Examples of a method of recording a video in a wide dynamic range include a RAW method (for example, a method of recording an RGB image of 14 bits) or a Log method (for example, a method of recording a YC image of 10 bits). In the RAW method, gamma correction processing of boosting a shadow part having a steep increase in a gamma (that is, a side of a small input value) is performed after recording using software. In the Log method, processing of converting an RGB gradation into a Log gradation is performed during recording. For example, as illustrated in FIG. 3, in a case where a sufficient bit depth is not secured, a decrease in image quality such as posterization called banding or a loss of a detailed structure (in other words, a loss of details) in the subject captured in the RAW image 75A is caused. Currently, there is demand for increasing a frame rate so that a residual image and/or a rolling distortion or the like caused by a rolling shutter does not occur. Since improvement of the frame rate and improvement of the bit depth are in a trade-off relationship, a high-performance image processing technology for establishing both of improvement of the frame rate and improvement of the bit depth is required.

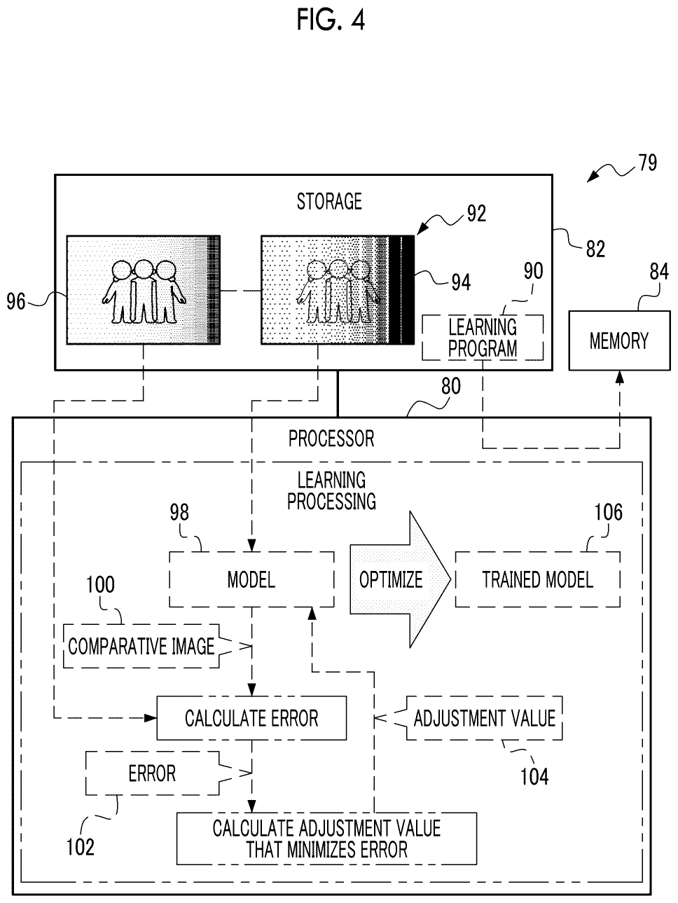

Therefore, in the present embodiment, the image processing engine 12 performs processing of enhancing image quality of the RAW image 75A (for example, processing including processing of increasing the bit depth for each pixel) by applying an AI to the RAW image 75A. Hereinafter, a method of generating the AI applied to the RAW image 75A will be described with reference to FIGS. 4 to 6.

FIG. 4 is a conceptual diagram illustrating an example of a configuration of a learning device 79. As illustrated in FIG. 4, the learning device 79 comprises a processor 80, a storage 82, and a memory 84. Hardware configurations of the processor 80, the storage 82, the memory 84, and the like in the learning device 79 are basically the same as the hardware configurations of the processor 62, the storage 64, the memory 66, and the like described above and thus, will not be described. In the example illustrated in FIG. 4, the learning device 79 is an example of a “learning device” according to the present disclosure.

A learning program 90 is stored in the storage 82. The processor 80 is an example of a “second processor” according to the present disclosure. The processor 80 reads out the learning program 90 from the storage 82 and executes the read learning program 90 on the memory 84. The processor 80 performs learning processing in accordance with the learning program 90 executed on the memory 84. The learning processing is processing of generating a trained model 106 from a model 98. The trained model 106 is generated by executing machine learning on the model 98 via the processor 80. That is, the trained model 106 is generated by optimizing the model 98 through the machine learning. For example, the model 98 is a neural network having several hundred million to several trillion interlayers. Examples of the model 98 include a model for a generative Al that generates and outputs an image having enhanced image quality compared to an input image (for example, an image having at least a larger bit depth than the input image).

The storage 82 stores a plurality of (for example, several ten thousand to several hundred billion) pieces of training data 92. The training data 92 is used for the machine learning of the model 98. That is, in the learning device 79, the processor 80 acquires the plurality of pieces of training data 92 from the storage 82 and performs the machine learning on the model 98 using the acquired plurality of pieces of training data 92.

The training data 92 is labeled data. For example, the labeled data is data in which an example image 94 (in other words, example data) and a correct answer image 96 (in other words, correct answer data) are associated with each other. The training data 92 is an example of “training data” according to the present disclosure. The example image 94 is an example of an “example image” according to the present disclosure. The correct answer image 96 is an example of a “correct answer image” according to the present disclosure.

The example image 94 is an image of a RAW format and has a smaller bit depth than the correct answer image 96. The example image 94 is an image assuming the RAW image 75A. For example, an image assuming the RAW image 75A refers to an image having the same image quality as the RAW image 75A including a bit depth. The bit depth refers to a value representing a gradation (that is, a value indicating details of color gradation representation). Examples of a term used synonymously with the bit depth include a bit length, the number of color bits, the number of bits, or a color depth.

In the present embodiment, an image obtained by actually imaging a sample subject (for example, a subject captured in the correct answer image 96 illustrated in FIG. 4) is used as the example image 94. However, this is merely an example. The image assuming the RAW image 75A may be a virtually generated image. Examples of the virtually generated image include an image generated by a generative AI or the like.

The correct answer image 96 is an image of the RAW format, like the example image 94. The correct answer image 96 is an image having enhanced image quality compared to the example image 94. Examples of the image having enhanced image quality include an image having a larger bit depth than the example image 94. In the present embodiment, the bit depth of the correct answer image 96 is 14 bits, and the bit depth of the example image 94 is 12 bits. However, these bit depths are merely examples. The present disclosure is also established with any bit depth in a case where the bit depth of the correct answer image 96 is larger than the bit depth of the example image 94.

The processor 80 acquires the training data 92 one piece at a time from the storage 82. The processor 80 inputs the example image 94 into the model 98 from the training data 92 acquired from the storage 82. In a case where the example image 94 is input, the model 98 generates a comparative image 100 that is an image (for example, an image of 14 bits) having a larger bit depth than the example image 94. The comparative image 100 is an image used to be compared with the correct answer image 96 associated with the example image 94 input into the model 98. In the present embodiment, the comparative image 100 is an example of an “evaluation target image” according to the present disclosure.

The processor 80 calculates an error 102 between the correct answer image 96 associated with the example image 94 input into the model 98 and the comparative image 100. The error 102 is an example of a “comparison result” according to the present disclosure. The processor 80 calculates a plurality of adjustment values 104 that minimize the error 102. The processor 80 adjusts a plurality of optimization variables in the model 98 using the plurality of adjustment values 104. For example, the plurality of optimization variables refer to a plurality of connection weights and a plurality of offset values included in the model 98.

The processor 80 repeats the series of processing of inputting the example image 94 into the model 98, calculating the error 102, calculating the plurality of adjustment values 104, and adjusting the plurality of optimization variables in the model 98, using the plurality of pieces of training data 92 stored in the storage 82. That is, the processor 80 optimizes the model 98 by adjusting the plurality of optimization variables in the model 98 using the plurality of adjustment values 104 that are calculated such that the error 102 is minimized for each of a plurality of example images 94 included in the plurality of pieces of training data 92 stored in the storage 82. The processor 80 generates the trained model 106 by optimizing the model 98. In a case where the example image 94 is input into the trained model 106 generated as described above, the trained model 106 generates and outputs an image having the same bit depth as the correct answer image 96 as an image corresponding to the input example image 94.

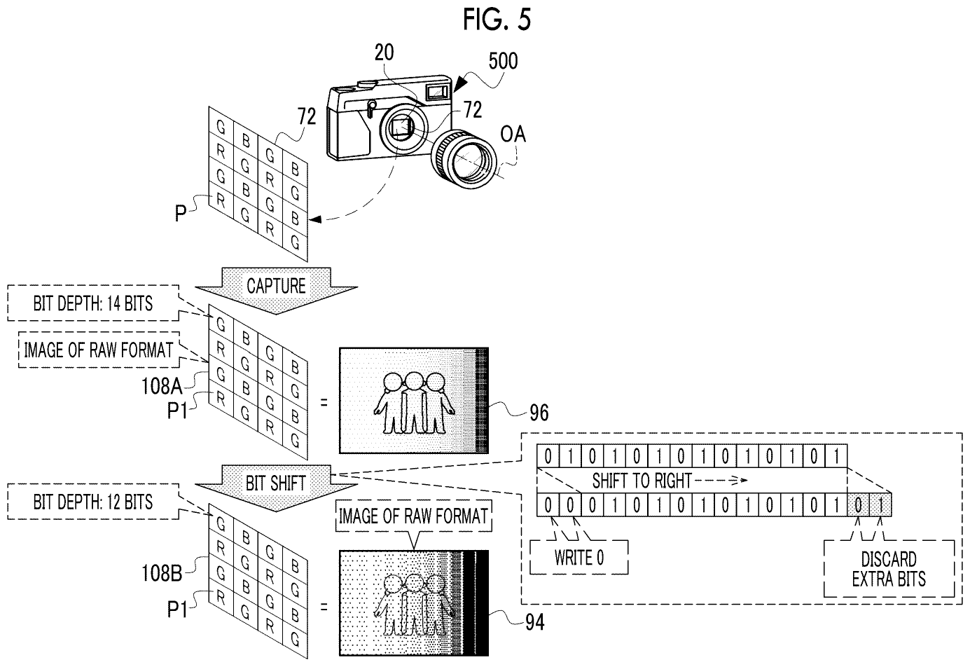

FIG. 5 is a conceptual diagram illustrating an example of a method of creating the example image 94 and the correct answer image 96. As illustrated in FIG. 5, in the present embodiment, an imaging apparatus 500 is used for creating the example image 94 and the correct answer image 96. The imaging apparatus 500 is an example of a “first imaging apparatus” according to the present disclosure.

As in the imaging apparatus 10, the image sensor 20 mounted on the imaging apparatus 500 is provided with the photoelectric conversion element 72. As in the imaging apparatus 10, the pixels P (that is, R pixels, G pixels, and B pixels) having different colors are regularly disposed in the photoelectric conversion element 72. An arrangement pattern of the pixels P having different colors is the same as that of the imaging apparatus 10. In the example illustrated in FIG. 5, a smaller number of pixels P (in the example illustrated in FIG. 5, 4×4 pixels) than the actual number of pixels P is illustrated for easy understanding of the present disclosure.

The imaging apparatus 500 is an imaging apparatus having the same configuration and the same specifications as the imaging apparatus 10 except that the imaging apparatus 500 can generate an image of the RAW format having a larger bit depth than that of the imaging apparatus 10. Thus, hereinafter, constituents of the imaging apparatus 500 will be designated by the same reference numerals as the constituents of the imaging apparatus 10 and will not be described.

The imaging apparatus 500 generates a first single image 108A of one frame as a RAW image having a bit depth of 14 bits by imaging the sample subject. The first single image 108A obtained by imaging the sample subject via the image sensor 20 of the imaging apparatus 500 is used as the correct answer image 96.

In the first single image 108A, pixels P1 having different colors are regularly disposed. The pixels P1 refer to pixels (in other words, image pixels) constituting the RAW image obtained by performing imaging via the image sensor 20 of the imaging apparatus 500. Positions of the pixels P1 in the RAW image obtained by performing imaging via the image sensor 20 of the imaging apparatus 500 match positions of the pixels P in the photoelectric conversion element 72 of the image sensor 20 mounted on the imaging apparatus 500.

In the example illustrated in FIG. 5, a second single image 108B is created based on the first single image 108A. The second single image 108B is an image of the RAW format having a bit depth of 12 bits. The second single image 108B is obtained by performing bit shifting of the first single image 108A. For example, the second single image 108B is created by shifting the bit depth of each of all pixels P1 of the first single image 108A to the right by 2 bits, writing “0” in two vacant digits of the most significant bits, and discarding two extra digits of the least significant bits generated by shifting to the right. The second single image 108B obtained as described above is used as the example image 94.

While the first single image 108A obtained by imaging the sample subject via the imaging apparatus 500 and the second single image 108B that is an image obtained by performing bit shifting of the first single image 108A are illustrated in the example illustrated in FIG. 5, this is merely an example. For example, the first single image 108A and/or the second single image 108B may be a virtual image generated by a generative AI. The generative AI may be an AI specialized in generating an image or a generative AI that generates and outputs the first single image 108A and/or the second single image 108B in accordance with input instruction data (a so-called prompt), such as ChatGPT using GPT-4 (searched on the internet <https://openai.com/gpt-4>) or the like.

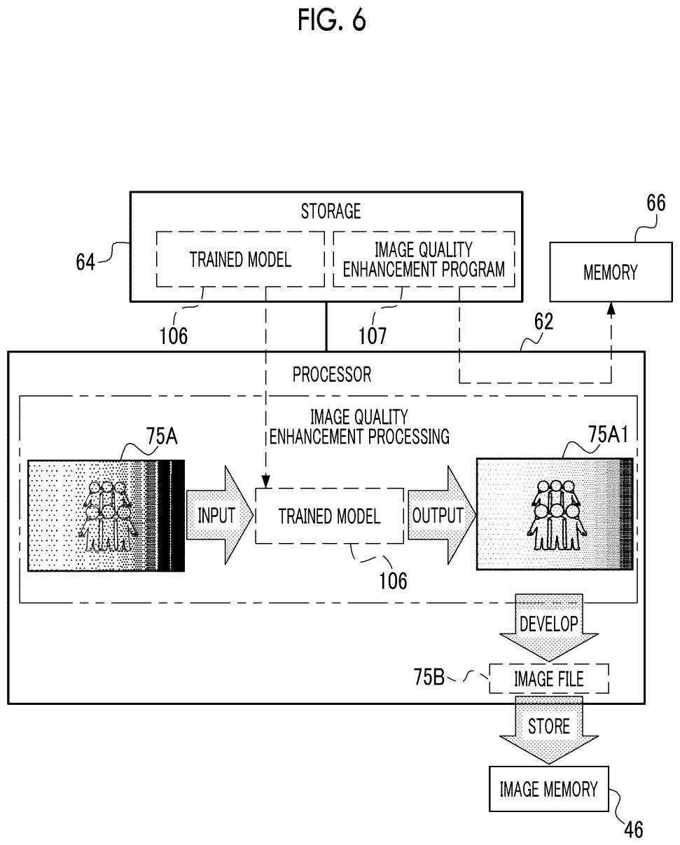

FIG. 6 is a conceptual diagram illustrating an example of an operation phase of the trained model 106 (that is, a phase in which the trained model 106 makes an inference) generated by performing the learning processing in the example illustrated in FIG. 4. As illustrated in FIG. 6, in the imaging apparatus 10, the storage 64 stores the trained model 106. The storage 64 also stores an image quality enhancement program 107. In the imaging apparatus 10, the processor 62 reads out the image quality enhancement program 107 from the storage 64 and executes the read image quality enhancement program 107 on the memory 66. The processor 62 performs image quality enhancement processing in accordance with the image quality enhancement program 107 executed on the memory 66. The image quality enhancement processing is processing of inputting the RAW image 75A (refer to FIG. 2) into the trained model 106 stored in the storage 64, causing the trained model 106 to generate and output a high image quality image 75A1 that is an image having enhanced image quality compared to the RAW image 75A, and causing the processor 62 to acquire the high image quality image 75A1. For example, the image having enhanced image quality compared to the RAW image 75A refers to an image having a larger bit depth than the RAW image 75A. Examples of the RAW image 75A illustrated in FIG. 6 include an image of 12 bits. Examples of the image having a larger bit depth than the RAW image 75A (that is, the high image quality image 75A1) include an image of 14 bits. In the present embodiment, the high image quality image 75A1 is an example of an “inference result” according to the present disclosure.

The processor 62 generates the image file 75B by performing the image processing including the development on the high image quality image 75A1 and stores the generated image file 75B in the image memory 46.

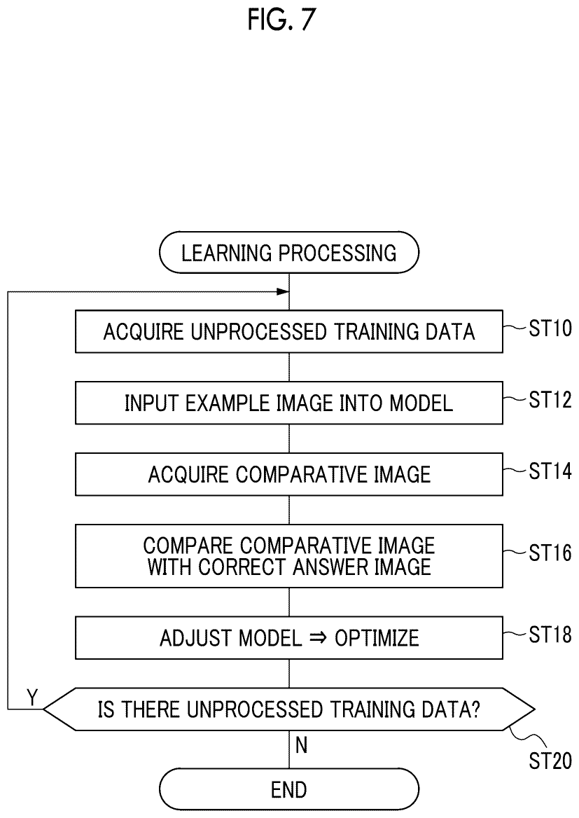

Next, an action of a part of the learning device 79 according to the present disclosure will be described with reference to FIG. 7. FIG. 7 illustrates an example of a flow of the learning processing executed by the processor 80. The flow of learning processing illustrated in FIG. 7 is an example of a “method of generating a trained model” according to the present disclosure.

In the learning processing illustrated in FIG. 7, first, in step ST10, processing of step ST10 in which the processor 80 acquires unprocessed training data 92 (that is, the training data 92 not used in the learning processing illustrated in FIG. 7) from the storage 82 is executed. Then, the learning processing transitions to step ST12.

In step ST12, the processor 80 inputs the example image 94 included in the training data 92 acquired in step ST10 into the model 98. After the processing of step ST12 is executed, the learning processing transitions to step ST14. The comparative image 100 is output from the model 98 by executing the processing of step ST12.

In step ST14, the processor 80 acquires the comparative image 100 output from the model 98. After the processing of step ST14 is executed, the learning processing transitions to step ST16.

In step ST16, the processor 80 compares the comparative image 100 acquired in step ST14 with the correct answer image 96 included in the training data 92 acquired in step ST10. After the processing of step ST16 is executed, the learning processing transitions to step ST18.

In step ST18, the processor 80 adjusts the model 98 using the plurality of adjustment values 104 obtained by comparing the comparative image 100 with the correct answer image 96 in step ST16. The model 98 is optimized by repeatedly executing the processing of step ST18 based on all pieces of the training data 92 stored in the storage 82. After the processing of step ST18 is executed, the learning processing transitions to step ST20.

In step ST20, the processor 80 determines whether or not the unprocessed training data 92 is stored in the storage 82. In step ST20, in a case where the unprocessed training data 92 is stored in the storage 82, a positive determination is made, and the learning processing transitions to step ST10. In step ST20, in a case where the unprocessed training data 92 is not stored in the storage 82, a negative determination is made, and the learning processing is finished.

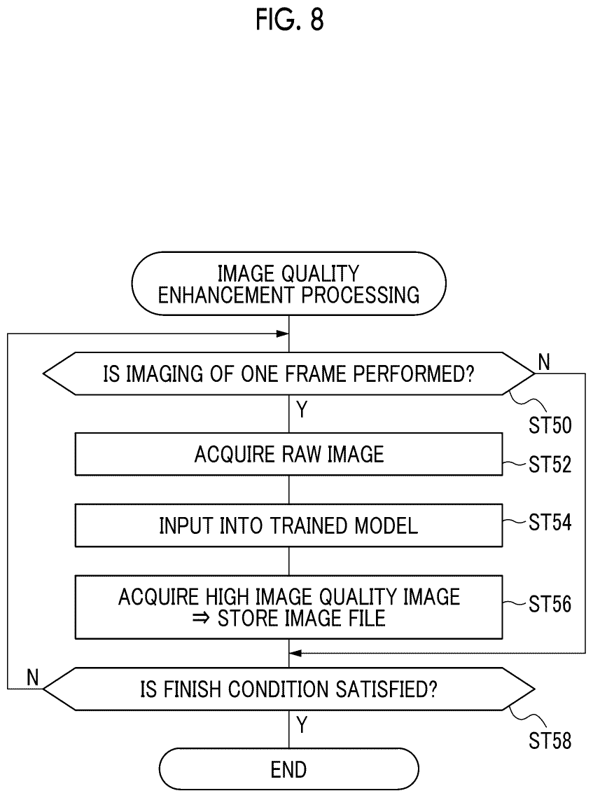

Next, an action of a part of the imaging apparatus 10 according to the present disclosure will be described with reference to FIG. 8. For convenience of description, this description is based on an assumption that the trained model 106 is already stored in the storage 64.

In the image quality enhancement processing illustrated in FIG. 8, first, in step ST50, the processor 62 determines whether or not imaging of one frame is performed by the image sensor 20. In step ST50, in a case where imaging of one frame is not performed by the image sensor 20, a negative determination is made, and the image quality enhancement processing transitions to step ST58. In a case where imaging of one frame is performed by the image sensor 20, a positive determination is made, and the image quality enhancement processing transitions to step ST52.

In step ST52, the processor 62 acquires the RAW image 75A from the image sensor 20. After the processing of step ST52 is executed, the image quality enhancement processing transitions to step ST54.

In step ST54, the processor 62 inputs the RAW image 75A acquired in step ST52 into the trained model 106. After the processing of step ST54 is executed, the image quality enhancement processing transitions to step ST56. By executing the processing of step ST54, the trained model 106 is caused to generate and output an image obtained by enhancing the image quality of the RAW image 75A (in other words, an image having a larger bit depth than the RAW image 75A), that is, the high image quality image 75A1.

In step ST56, the processor 62 acquires the high image quality image 75A1. The processor 62 generates the image file 75B based on the high image quality image 75A1 and stores the image file 75B in the image memory 46. After the processing of step ST56 is executed, the image quality enhancement processing transitions to step ST58.

In step ST58, the processor 62 determines whether or not a condition (hereinafter, referred to as a “finish condition”) under which the image quality enhancement processing is finished is satisfied. Examples of the finish condition include a condition that an instruction to finish the image quality enhancement processing is received by the reception device 76. In step ST58, in a case where the finish condition is not satisfied, a negative determination is made, and the image quality enhancement processing transitions to step ST50. In step ST58, in a case where the finish condition is satisfied, a positive determination is made, and the image quality enhancement processing is finished.

As described above, the training data 92 according to the present embodiment is used for the machine learning of the model 98. The trained model 106 is generated by performing the machine learning on the model 98. The training data 92 comprises the example image 94 and the correct answer image 96, in which the example image 94 and the correct answer image 96 are associated with each other. The example image 94 is an image having a smaller bit depth than the correct answer image 96. Accordingly, the high image quality image 75A1 can be generated as an image having a larger bit depth than the RAW image 75A by inputting the RAW image 75A into the trained model 106 configured as described above.

That is, the high image quality image 75A1 having a larger bit depth than the RAW image 75A obtained by performing imaging via the imaging apparatus 10 (in other words, an image having high bit accuracy exceeding original performance of the imaging apparatus 10 (that is, performance before the trained model 106 is mounted)) can be obtained. Consequently, a loss of a detailed structure of the subject and occurrence of the banding on the image can be suppressed. Even in a case where the RAW image 75A having a bit depth less than a certain level is generated at a frame rate greater than or equal to a certain level by the imaging apparatus 10, the high image quality image 75A1 having a larger bit depth than the RAW image 75A can be generated by the trained model 106 mounted on the imaging apparatus 10 without decreasing the frame rate.

In the present embodiment, both of the example image 94 and the correct answer image 96 are images of the RAW format. Accordingly, the high image quality image 75A1 of the RAW format can be generated as an image having a larger bit depth than the RAW image 75A by inputting the RAW image 75A into the trained model 106.

In the present embodiment, the example image 94 having a smaller bit depth than the correct answer image 96 is created by performing bit shifting of the correct answer image 96. Thus, the example image 94 can be easily created compared to the example image 94 that is created independently of the correct answer image 96. This can contribute to reduction of an effort required for creating the training data 92.

In the present embodiment, the correct answer image 96 is generated by imaging the sample subject via the imaging apparatus 500. The example image 94 is created from the correct answer image 96 generated as described above. Thus, a characteristic of the imaging apparatus 500 can be reflected on the example image 94 and the correct answer image 96. In a case where a type and specifications of the imaging apparatus 500 are the same as those of the imaging apparatus 10, a characteristic of the imaging apparatus 10 can also be reflected on the example image 94 and the correct answer image 96. Accordingly, the trained model 106 can be caused to generate and output the high image quality image 75A1 in which a decrease in image quality caused by the characteristic of the imaging apparatus 10 is suppressed.

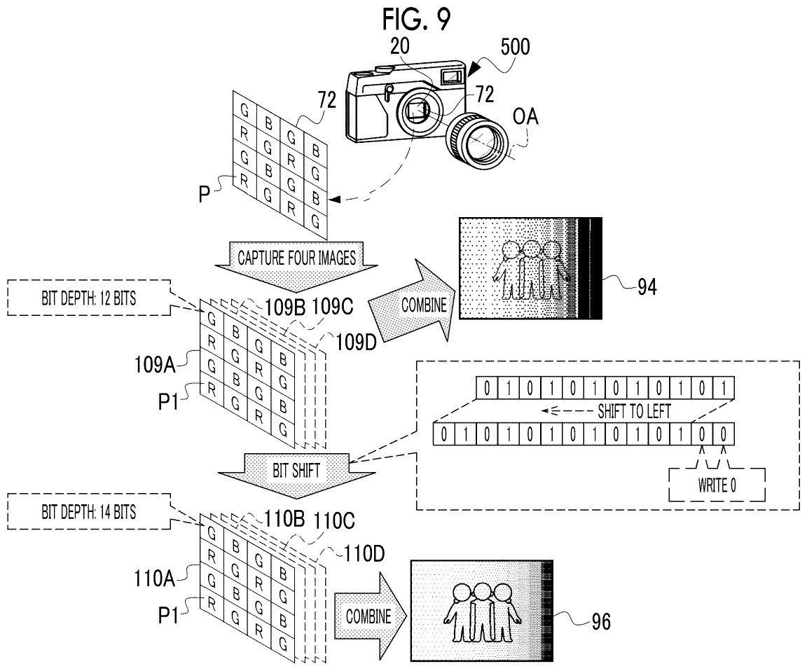

While an example of a form of using the first single image 108A of one frame obtained by imaging the sample subject via the imaging apparatus 500 as the correct answer image 96 and creating the example image 94 by performing bit shifting of the correct answer image 96 is illustrated in the embodiment, this is merely an example. The example image 94 and the correct answer image 96 may be created based on a plurality of images. In order to implement this, for example, as illustrated in FIG. 9, the imaging apparatus 500 first generates third to sixth single images 109A to 109D as images of the RAW format having a bit depth of 12 bits by imaging the sample subject. The example image 94 is created by combining the third to sixth single images 109A to 109D. For example, combining the third to sixth single images 109A to 109D means calculating an arithmetic mean of the third to sixth single images 109A to 109D in units of the pixels P1 at positions corresponding to each other. The example image 94 illustrated in FIG. 9 is an example of a “representative image” according to the present disclosure.

In the example illustrated in FIG. 9, the correct answer image 96 is created based on seventh to tenth single images 110A to 110D. The seventh to tenth single images 110A to 110D correspond to the third to sixth single images 109A to 109D and are images of the RAW format having a larger bit depth than the third to sixth single images 109A to 109D. The bit depths of the seventh to tenth single images 110A to 110D are 14 bits. The seventh single image 110A is obtained by performing bit shifting of the third single image 109A. For example, the seventh single image 110A is created by shifting the bit depth of each of all of the pixels P1 of the third single image 109A to the left by 2 bits and writing “0” in two vacant digits of the least significant bits generated by shifting to the left. In the same manner, the eighth single image 110B is obtained by performing bit shifting of the fourth single image 109B. The ninth single image 110C is obtained by performing bit shifting of the fifth single image 109C. The tenth single image 110D is obtained by performing bit shifting of the sixth single image 109D.

The correct answer image 96 is created by combining the seventh to tenth single images 110A to 110D. For example, combining the seventh to tenth single images 110A to 110D means calculating an arithmetic mean of the seventh to tenth single images 110A to 110D in units of the pixels P1 at positions corresponding to each other.

As described above, in the example illustrated in FIG. 9, the example image 94 is obtained by combining the third to sixth single images 109A to 109D (for example, calculating the arithmetic mean of the third to sixth single images 109A to 109D in units of the pixels P1 at positions corresponding to each other). The correct answer image 96 is obtained by combining the seventh to tenth single images 110A to 110D having a larger bit depth than the third to sixth single images 109A to 109D (for example, calculating the arithmetic mean of the seventh to tenth single images 110A to 110D in units of the pixels P1 at positions corresponding to each other). Thus, the correct answer image 96 having a larger bit depth than the example image 94 can be easily obtained.

In the example illustrated in FIG. 9, the example image 94 is obtained by combining the third to sixth single images 109A to 109D that are bases for the seventh to tenth single images 110A to 110D used for obtaining the correct answer image 96. That is, the example image 94 is obtained using images representing the third to sixth single images 109A to 109D used for obtaining the correct answer image 96. Therefore, the example image 94 having a high affinity with the correct answer image 96 can be efficiently obtained compared to the example image 94 that is obtained regardless of the correct answer image 96.

In the example illustrated in FIG. 9, images obtained by performing bit shifting of the third to sixth single images 109A to 109D are used as the seventh to tenth single images 110A to 110D. Accordingly, the correct answer image 96 assuming the high image quality image 75A1 generated and output by the trained model 106 in a phase in which the trained model 106 is operated in the imaging apparatus 10 (that is, the correct answer image 96 having the same bit depth as the high image quality image 75A1) can be easily obtained.

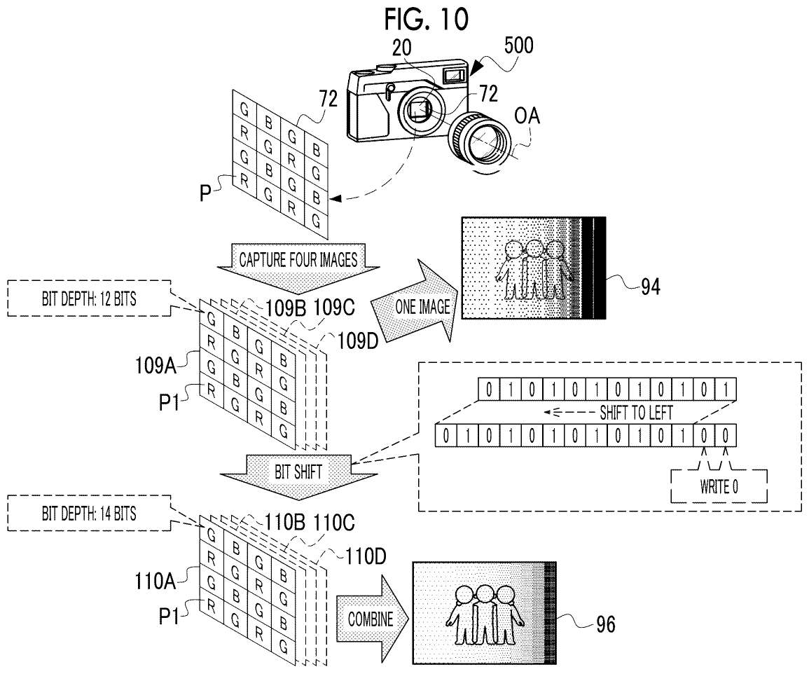

While an example of a form in which the example image 94 is created by combining the third to sixth single images 109A to 109D is illustrated in the example illustrated in FIG. 9, this is merely an example. For example, as illustrated in FIG. 10, any one of the third to sixth single images 109A to 109D before bit shifting may be employed as the example image 94. In this case, for example, in a case where the third to sixth single images 109A to 109D are images obtained by continuously performing imaging, an image obtained between the third single image 109A and the sixth single image 109D, that is, the fourth single image 109B or the fifth single image 109C, may be employed as the example image 94.

An image obtained by combining the fourth single image 109B and the fifth single image 109C (for example, calculating an arithmetic mean of the fourth single image 109B and the fifth single image 109C in units of the pixels P1 at positions corresponding to each other) may be employed as the example image 94. An image generated based on a plurality of images of three or less among the third to sixth single images 109A to 109D before bit shifting (that is, an image obtained by combining a plurality of images of three or less among the third to sixth single images 109A to 109D before bit shifting) may be employed as the example image 94.

Any one of the third to sixth single images 109A to 109D used as the example image 94 or the image obtained by combining the plurality of images of three or less among the third to sixth single images 109A to 109D is an example of the “representative image” according to the present disclosure.

All of the third to sixth single images 109A to 109D before bit shifting are images used for obtaining the correct answer image 96. Thus, as illustrated in FIG. 10, by employing any one of the third to sixth single images 109A to 109D as the example image 94 or by employing the image obtained by combining the plurality of images of three or less among the third to sixth single images 109A to 109D as the example image 94, the example image 94 having a high affinity with the correct answer image 96 can be efficiently obtained compared to the example image 94 that is obtained regardless of the correct answer image 96.

While an example of a form in which any of the third to sixth single images 109A to 109D is used as the example image 94 is illustrated in the example illustrated in FIG. 10, this is merely an example. An image generated based on at least one of the third to sixth single images 109A to 109D may be used as the example image 94. For example, the image generated based on at least one of the third to sixth single images 109A to 109D refers to an image obtained by processing at least one of the third to sixth single images 109A to 109D. Examples of the image obtained by processing at least one of the third to sixth single images 109A to 109D include an image obtained by converting one of the third to sixth single images 109A to 109D from the RAW format to a Log format, an image obtained by performing any image quality improvement processing (for example, noise reducing and/or edge part extraction processing) on one of the third to sixth single images 109A to 109D, or an image obtained by converting a plurality of images among the third to sixth single images 109A to 109D from the RAW format to the Log format and calculating an arithmetic mean of the plurality of images.

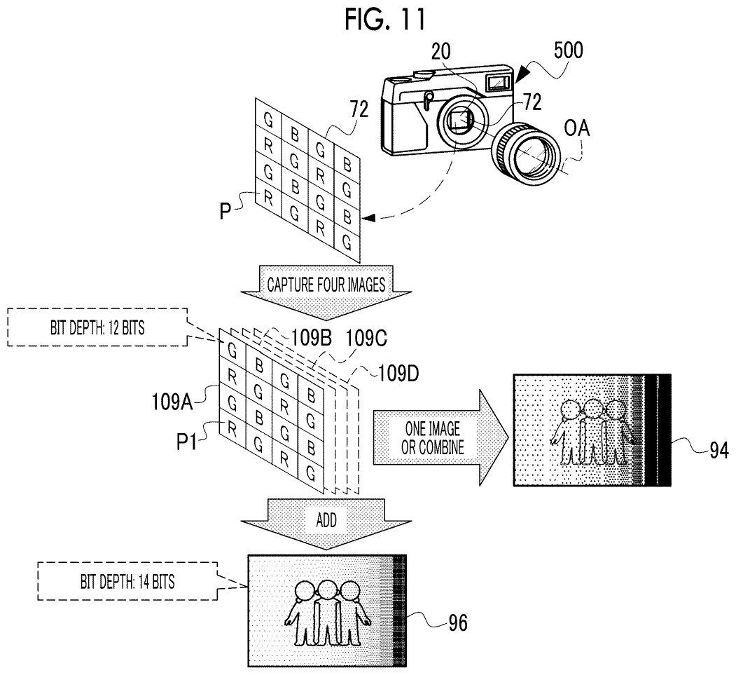

While an example of a form in which the correct answer image 96 is created by combining the seventh to tenth single images 110A to 110D is illustrated in the example illustrated in FIG. 9, this is merely an example. For example, as illustrated in FIG. 11, the correct answer image 96 having a bit depth of 14 bits may be created by adding the third to sixth single images 109A to 109D in units of the pixels P1 at positions corresponding to each other. Doing so eliminates need for creating the seventh to tenth single images 110A to 110D from the third to sixth single images 109A to 109D (that is, eliminates need for performing bit shifting of the third to sixth single images 109A to 109D). Thus, the correct answer image 96 having a bit depth of 14 bits can be easily created compared to that in the example illustrated in FIG. 9.

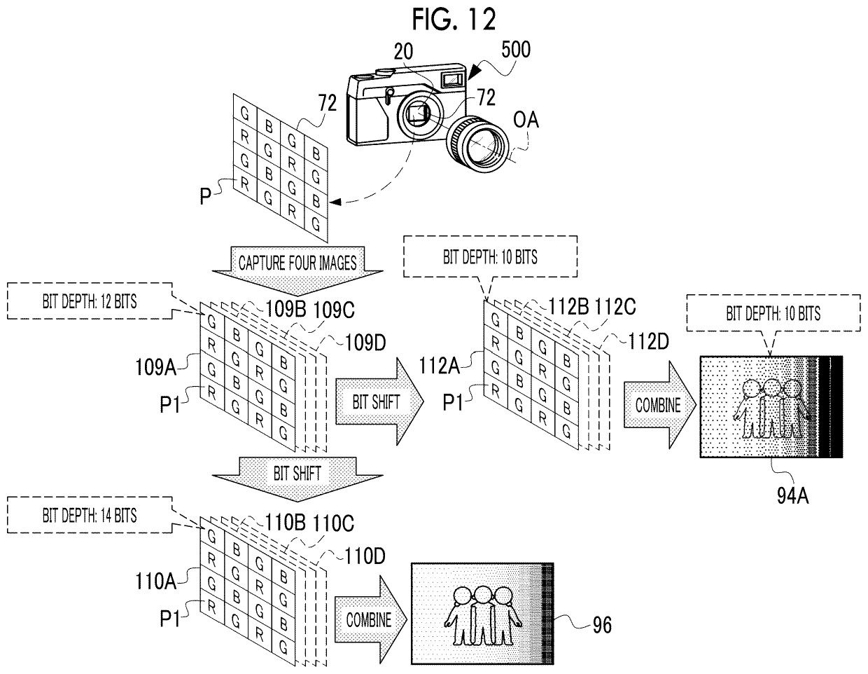

While the example image 94 is illustrated in the embodiment, this is merely an example. For example, as illustrated in FIG. 12, the present disclosure is also established in a case where an example image 94A is used instead of the example image 94. The example image 94A is different from the example image 94 in that the example image 94A has a smaller bit depth than the example image 94. That is, while the bit depth of the example image 94 is 12 bits, the bit depth of the example image 94A is 10 bits. In the example illustrated in FIG. 12, the example image 94A is created based on eleventh to fourteenth single images 112A to 112D having a smaller bit depth than the third to sixth single images 109A to 109D.

In the example illustrated in FIG. 12, the eleventh to fourteenth single images 112A to 112D having a smaller bit depth than the third to sixth single images 109A to 109D by 2 bits (that is, the eleventh to fourteenth single images 112A to 112D having a bit depth of 10 bits) are created by performing bit shifting of the third to sixth single images 109A to 109D in the same manner as creation of the second single image 108B having a smaller bit depth than the first single image 108A by 2 bits by performing bit shifting of the first single image 108A in the embodiment. The example image 94A is created by combining the eleventh to fourteenth single images 112A to 112D. For example, combining the eleventh to fourteenth single images 112A to 112D means calculating an arithmetic mean of the eleventh to fourteenth single images 112A to 112D in units of the pixels P1 at positions corresponding to each other.

A difference between the bit depth of the example image 94A obtained as described above and the bit depth of the correct answer image 96 is larger than a difference between the bit depth of the example image 94 and the bit depth of the correct answer image 96. Thus, the trained model 106 generated by optimizing the model 98 using the example image 94A and the correct answer image 96 for the machine learning of the model 98 can increase a difference between bit depths of input and output images compared to the trained model 106 generated by optimizing the model 98 using the example image 94 and the correct answer image 96 for the machine learning of the model 98. For example, in a case where the RAW image 75A having a bit depth of 10 bits is input into the trained model 106 generated by optimizing the model 98 using the example image 94A and the correct answer image 96 for the machine learning of the model 98, the trained model 106 can be caused to generate and output the high image quality image 75A1 having a larger bit depth than the input RAW image 75A by 4 bits (that is, the high image quality image 75A1 of 14 bits).

While an example of a form in which the correct answer image 96 is created by calculating the arithmetic mean of the seventh to tenth single images 110A to 110D is illustrated in the example illustrated in FIG. 12, this is merely an example. The correct answer image 96 having a bit depth of 12 bits may be created by calculating the arithmetic mean of the third to sixth single images 109A to 109D.

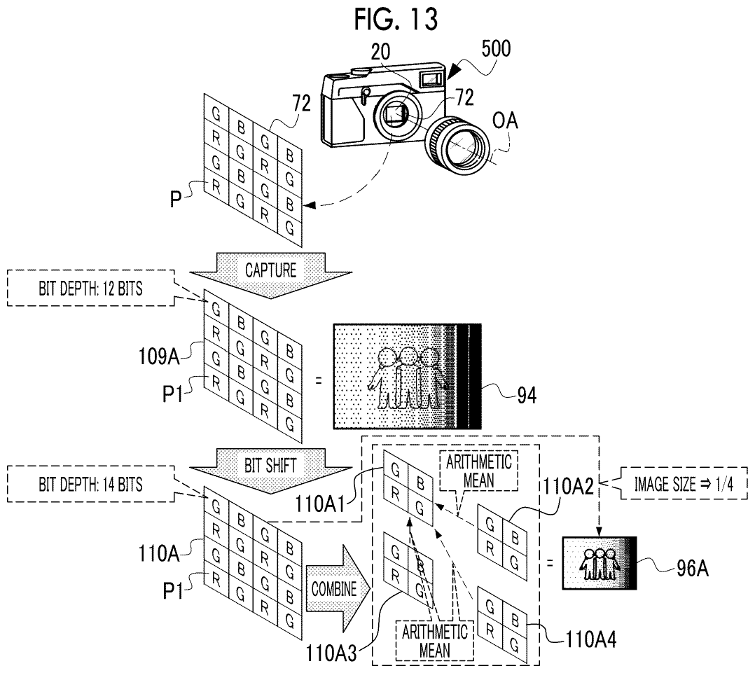

While an example of a form in which the correct answer image 96 is created by combining the seventh to tenth single images 110A to 110D is illustrated in the example illustrated in FIG. 10, this is merely an example. For example, as illustrated in FIG. 13, the present disclosure is also established in a case where a correct answer image 96A is used instead of the correct answer image 96. The correct answer image 96A is different from the correct answer image 96 in that while the bit depth is the same, an image size of the correct answer image 96A is ¼ of that of the correct answer image 96.

The correct answer image 96A is created based on a plurality of image regions obtained by dividing the seventh single image 110A. While an example of a form in which the seventh single image 110A is divided is illustrated, this is merely an example. Any of the eighth to tenth single images 110B to 110D (refer to FIGS. 9 to 12) may be divided.

The seventh single image 110A is divided into a processing target region 110A1, a first adjacent region 110A2 adjacent to a right side of the processing target region 110A1, a second adjacent region 110A3 adjacent to a lower side of the processing target region 110A1, and a third adjacent region 110A4 adjacent to a lower right side of the processing target region 110A1. The processing target region 110A1 is an example of a “processing target region” according to the present disclosure. The first adjacent region 110A2, the second adjacent region 110A3, and the third adjacent region 110A4 are examples of a “corresponding region” according to the present disclosure.

Any of the processing target region 110A1, the first adjacent region 110A2, the second adjacent region 110A3, and the third adjacent region 110A4 is a set (in other words, a block) of 2×2 pixels P1 and is defined by an R pixel, a G pixel, a G pixel, and a B pixel of arrangement patterns corresponding to each other in the seventh single image 110A. That is, positions of the R pixel, the G pixel, the G pixel, and the B pixel are uniform among the processing target region 110A1, the first adjacent region 110A2, the second adjacent region 110A3, and the third adjacent region 110A4.

Therefore, in the example illustrated in FIG. 13, an image having the same bit depth as the bit depth of the seventh single image 110A is created as the correct answer image 96A by combining the processing target region 110A1 with the first adjacent region 110A2, the second adjacent region 110A3, and the third adjacent region 110A4. For example, combining the first adjacent region 110A2, the second adjacent region 110A3, and the third adjacent region 110A4 means calculating an arithmetic mean of the processing target region 110A1, the first adjacent region 110A2, the second adjacent region 110A3, and the third adjacent region 110A4 in units of the pixels P1 at positions corresponding to each other.

As described above, the correct answer image 96A created by combining the first adjacent region 110A2, the second adjacent region 110A3, and the third adjacent region 110A4 obtained by dividing the seventh single image 110A has the same bit depth as the seventh single image 110A and has an image size that is ¼ of that of the seventh single image 110A. That is, the correct answer image 96A has the same bit depth as the correct answer image 96 and has an image size that is ¼ of that of the correct answer image 96. Accordingly, in a case where the RAW image 75A is input into the trained model 106 generated by optimizing the model 98 by optimizing the model 98 using the example image 94 and the correct answer image 96A for the machine learning of the model 98, the trained model 106 can be caused to generate and output the high image quality image 75A1 having a larger bit depth and a smaller image size than the input RAW image 75A (that is, the high image quality image 75A1 having a bit depth of 14 bits and an image size reduced to ¼). While a Bayer arrangement is illustrated, other types of arrangement patterns such as a quad Bayer arrangement may be used to combine a plurality of divided regions that have corresponding arrangement patterns in an image (that is, an image corresponding to the seventh single image 110A) and that are adjacent to each other (for example, in the quad Bayer arrangement, a plurality of divided regions each consisting of a plurality of pixels of the same color that are adjacent to each other). For example, as in the quad Bayer arrangement, in a case where an adjacent pixel that has the same color as a processing target pixel (that is, one attention pixel) and that is regularly adjacent to the processing target pixel is present in the image (that is, an image subjected to bit shifting), an image corresponding to the correct answer image 96A may be created by combining (for example, calculating an arithmetic mean of) the processing target pixel with at least one adjacent pixel.

While an example of a form in which the processing target region 110A1 is combined with all of the first adjacent region 110A2, the second adjacent region 110A3, and the third adjacent region 110A4 is illustrated in the example illustrated in FIG. 13, this is merely an example. The processing target region 110A1 may be combined with two or less of the first adjacent region 110A2, the second adjacent region 110A3, and the third adjacent region 110A4, and the rest may be discarded.

While an example of a form in which the image size is reduced to ¼ is illustrated in the example illustrated in FIG. 13, this is merely an example. The image size can be downsized to other than ¼. In this case, the number of divisions of the seventh single image 110A may be changed in accordance with the image size, and the plurality of image regions obtained by dividing the seventh single image 110A may be combined.

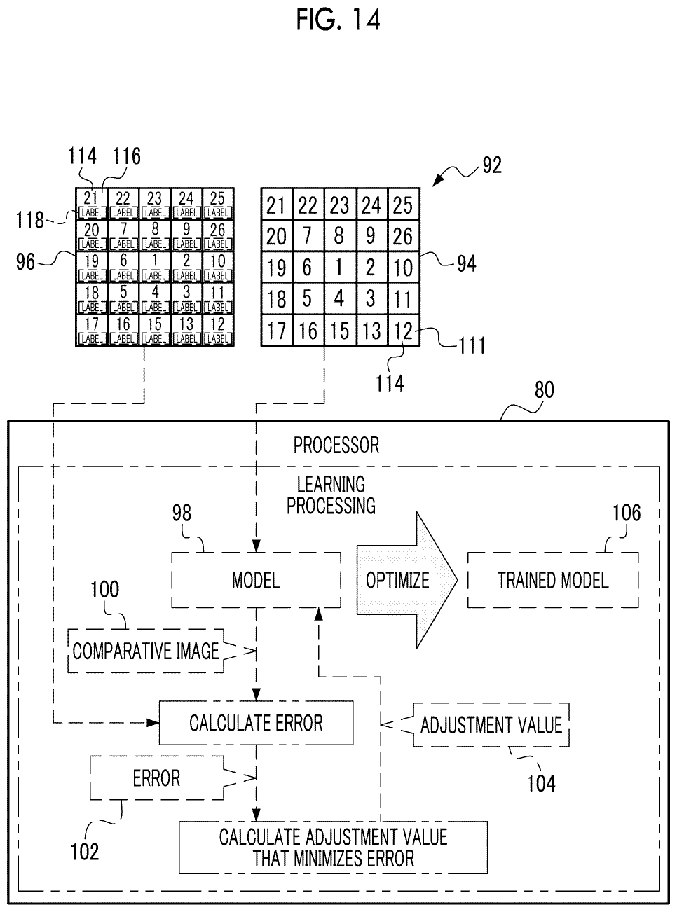

While an example of a form of increasing the bit depth of the entire RAW image 75A as an example of enhancing the image quality of the RAW image 75A is illustrated in the embodiment, a further increase in the image quality of the RAW image 75A may be implemented by dividing the RAW image 75A into a plurality of image regions and improving image quality of a different category from the bit depth for each image region. In this case, for example, as illustrated in FIG. 14, the example image 94 is divided into a plurality of first image regions 111. In the example illustrated in FIG. 14, 5×5 first image regions 111 are illustrated as an example of the plurality of first image regions 111. An image height 114 related to an optical system of the imaging apparatus 500 is assigned to each of the plurality of first image regions 111. Examples of the image height related to the optical system of the imaging apparatus 500 include an image height of the imaging lens 40 (refer to FIG. 2). The imaging lens 40 is an example of an “optical system” according to the present disclosure. The image height 114 is an example of a “characteristic of the second imaging apparatus” and an “image height” according to the present disclosure.

In the example illustrated in FIG. 14, the correct answer image 96 is divided into a plurality of second image regions 116 corresponding to the plurality of first image regions 111. In the example illustrated in FIG. 14, 5×5 second image regions 116 are illustrated as an example of the plurality of second image regions 116.

Image quality of each of the example image 94 and the correct answer image 96 includes image quality of a different category from the bit depth. Examples of the image quality of a different category from the bit depth include image quality determined by the image height 114 that is one characteristic of the imaging apparatus 500. Examples of the image quality determined by the image height 114 include shading of the imaging lens 40 and/or shading on the light-receiving surface 72A. For example, the shading of the imaging lens 40 refers to a phenomenon of gradual darkening from the optical axis OA of the imaging lens 40 along a radial direction (in other words, a phenomenon of a gradual decrease in a light quantity from a center to an edge part of the imaging lens 40). The shading on the light-receiving surface 72A refers to a phenomenon of a change in a signal-to-noise ratio from a center to an edge part of the light-receiving surface 72A (in other words, a phenomenon of unevenness in the signal-to-noise ratio from the center to the edge part of the light-receiving surface 72A). Generally, an edge part portion of the light-receiving surface 72A is likely to be affected by an aberration of an edge part portion of the imaging lens 40 and thus, is likely to generate an artifact.

Therefore, in a case of dividing the example image 94 into the plurality of first image regions 111 and dividing the correct answer image 96 into the plurality of second image regions 116, the image height 114 is assigned to each of the plurality of first image regions 111 and each of the plurality of second image regions 116. A label 118 with which the image quality of the correct answer image 96 of a different category from the bit depth can be specified is assigned to each of the plurality of second image regions 116.

The image height 114 is an indicator of a degree of separation from the center of the imaging lens 40. As a value of the image height 114 is increased, image quality is darkened. Thus, the image height 114 for each second image region 116 is associated with the label 118 as an indicator indicating a degree of darkness.

While the image quality determined by the image height 114 is described as the image quality of a different category from the bit depth is illustrated, this is merely an example. For example, since it is important to separately recognize noise and a normal image signal in a dynamic range of a shadow portion via the trained model 106, noise determined by the characteristic of the imaging apparatus 500 of the same type and the same specifications as the imaging apparatus 10 (for example, noise caused by a characteristic of the image sensor 20) may be superimposed on the example image 94 and the correct answer image 96, and information with which inclusion of noise and a type of noise can be specified may be included in the label 118.

Even in a case where a defective pixel, an aberration, a flare, a ghost, and/or a blur occurs because of the characteristic of the imaging apparatus 500, information with which the defective pixel, the aberration, the flare, the ghost, and/or the blur can be specified may be included in the label 118 in the same manner.

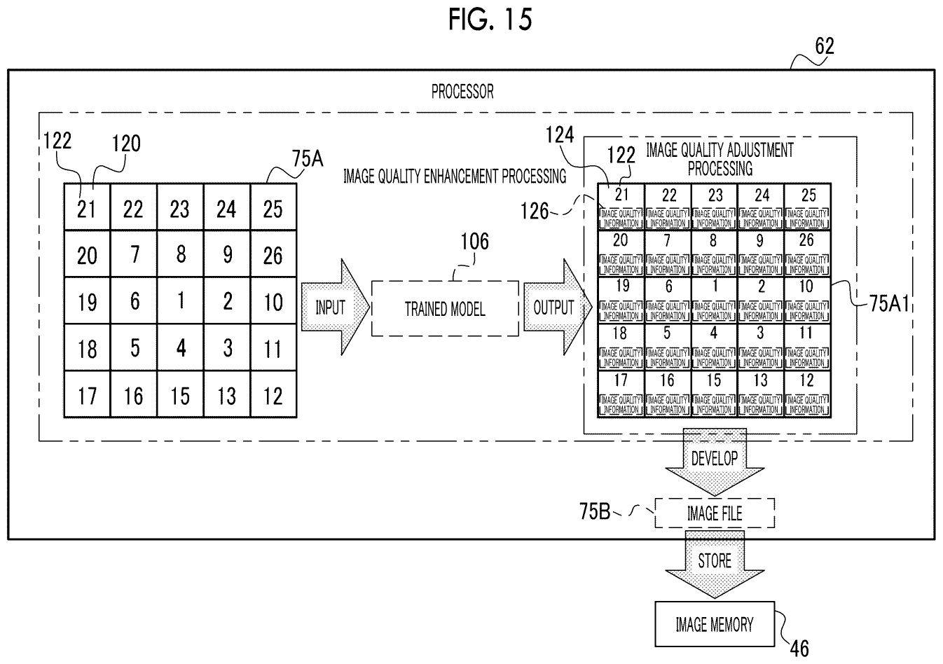

For example, as illustrated in FIG. 15, the RAW image 75A is divided into a plurality of third image regions 120 in the same manner as division of the example image 94 by the plurality of first image regions 111. In the example illustrated in FIG. 15, 5×5 third image regions 120 are illustrated. An image height 122 of the imaging lens 40 mounted on the imaging apparatus 10 is assigned to each of the plurality of third image regions 120.

As illustrated in FIG. 15, the trained model 106 generated by optimizing the model 98 using the example image 94 and the correct answer image 96 illustrated in FIG. 14 for the machine learning of the model 98 is used in the image quality enhancement processing performed by the processor 62. In a case where the RAW image 75A is input into the trained model 106, the trained model 106 generates and outputs the high image quality image 75A1. The high image quality image 75A1 is divided into a plurality of fourth image regions 124 in the same manner as division of the RAW image 75A by the plurality of third image regions 120. In the example illustrated in FIG. 15, 5×5 fourth image regions 124 are illustrated. Each fourth image region 124 is assigned the same image height 122 as the third image region 120 at a corresponding position. Image quality information 126 is also assigned to each fourth image region 124. The image quality information 126 is information for specifying image quality of the fourth image regions 124 (for example, information for specifying image quality determined by the image height 122).

The image quality enhancement processing includes image quality adjustment processing. The image quality adjustment processing is processing of adjusting the image quality of the fourth image regions 124 (for example, processing of improving the image quality) in accordance with the image quality information 126. In the image quality adjustment processing, the image quality of each of all of the fourth image regions 124 is adjusted (for example, shading, a defective pixel, an aberration, a flare, a ghost, and/or a blur is adjusted) in accordance with the image quality information 126 assigned to each fourth image region 124. Accordingly, image quality of the entire high image quality image 75A1 is adjusted by adjusting the image quality of each of all of the fourth image regions 124. The high image quality image 75A1 of which the image quality is adjusted is converted into a file in the same manner as the embodiment, and the image file 75B obtained by converting the high image quality image 75A1 into a file is stored in the image memory 46.

As described above, the example image 94 is divided into the plurality of first image regions 111, and the correct answer image 96 is divided into the plurality of second image regions 116 corresponding to the plurality of first image regions 111. By configuring the example image 94 and the correct answer image 96 as described above, the machine learning can be performed on the model 98 for each first image region 111.

The label 118 is assigned to each of the plurality of second image regions 116. The label 118 is information with which image quality of the first image regions 111 at positions corresponding to the second image regions 116 to which the label 118 is assigned can be specified. Accordingly, in a case where the RAW image 75A is input into the trained model 106 optimized by performing the machine learning on the model 98 using the correct answer image 96 and the example image 94 configured as described above, the image quality can be specified for each fourth image region 124 of the high image quality image 75A1 generated by the trained model 106. In a case where the image quality can be specified for each fourth image region 124 as described above, the image quality can be adjusted for each fourth image region 124 through the image quality adjustment processing. The image quality specified from the label 118 assigned to the second image regions 116 is determined by the characteristic of the imaging apparatus 500. Accordingly, the image quality determined by the characteristic (for example, the image height 114) of the imaging apparatus 500 can be specified for each fourth image region 124 of the high image quality image 75A1 generated by the trained model 106.

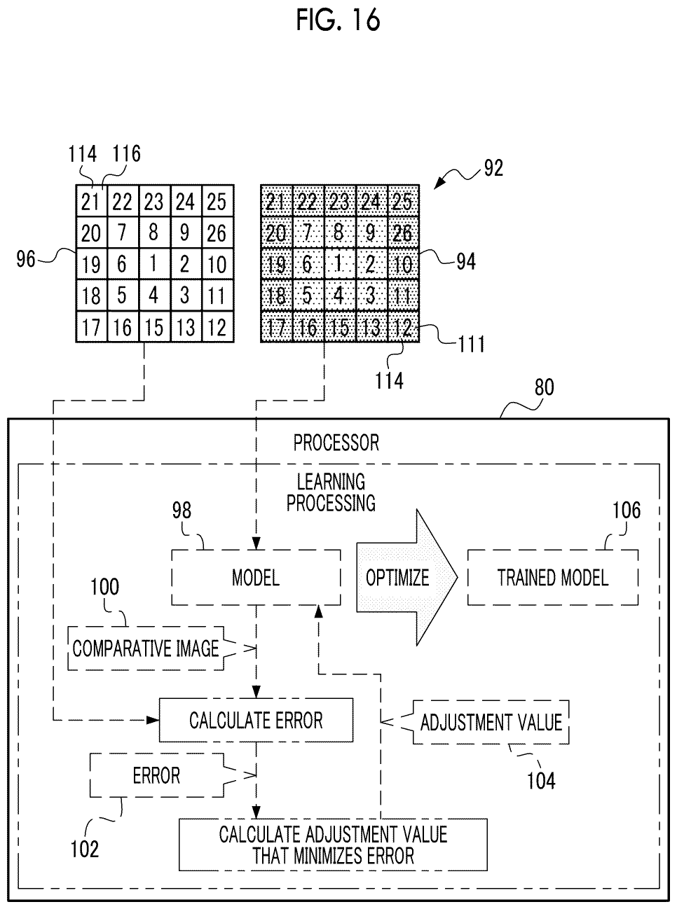

While an example of a form in which the label 118 is assigned for each second image region 116 is illustrated in the example illustrated in FIG. 14, the present disclosure is not limited to this. The label 118 may not be assigned for each second image region 116. For example, as illustrated in FIG. 16, an image in which a difference in brightness and darkness caused in accordance with the image height 114 in the example image 94 is eliminated for each second image region 116 may be used as the correct answer image 96. In this case, the trained model 106 generates and outputs an image in which a difference in brightness and darkness caused in accordance with the image height 122 is eliminated as the high image quality image 75A1. Thus, the image quality adjustment processing illustrated in FIG. 15 is not necessary.

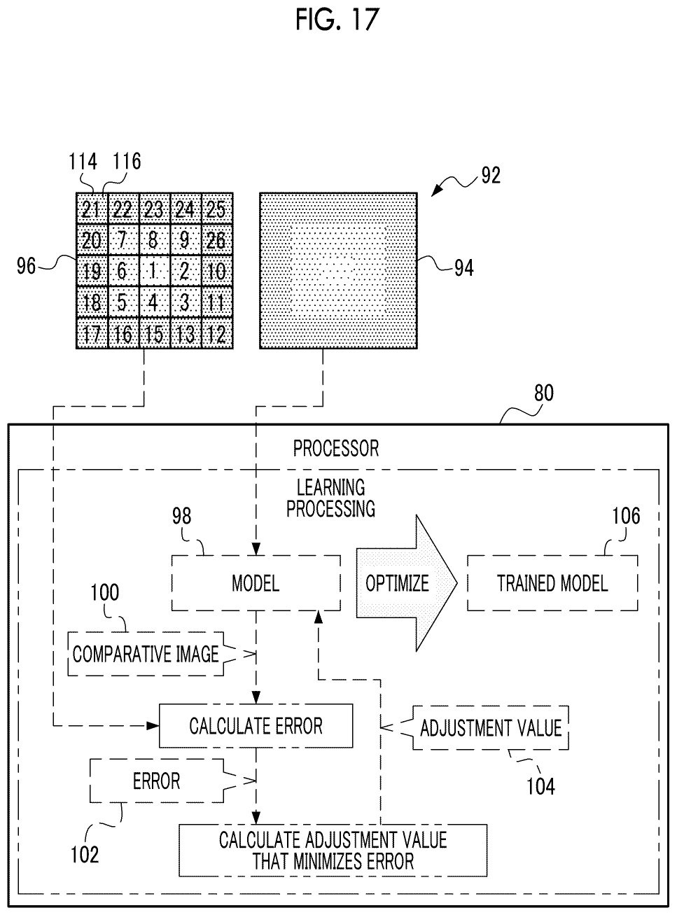

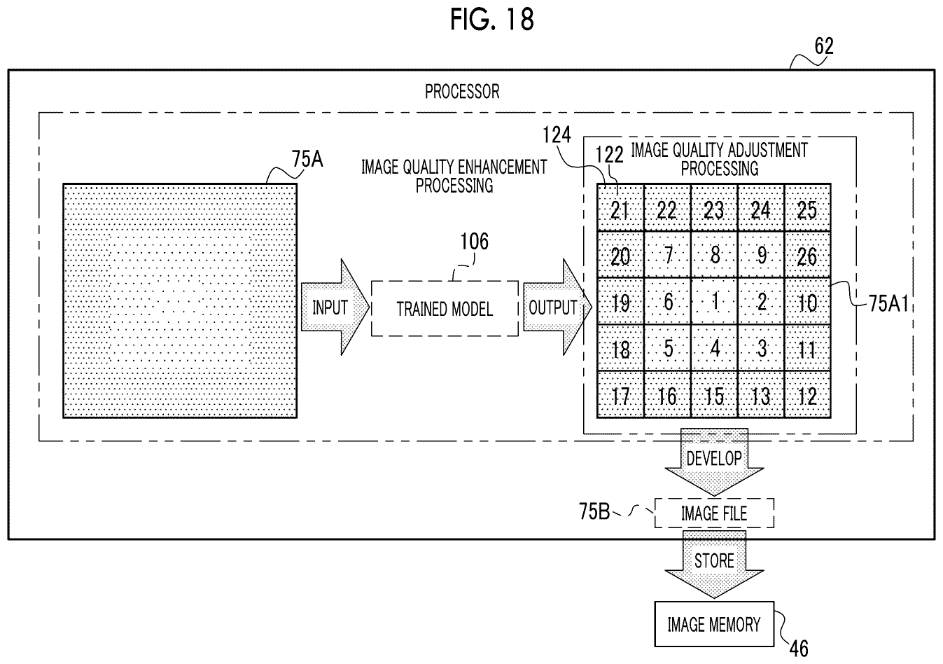

While an example of a form in which the image height 114 is assigned to each first image region 111 of the example image 94 is illustrated in the examples illustrated in FIGS. 14 and 16, this is merely an example. For example, as illustrated in FIG. 17, the example image 94 may not be divided into the plurality of first image regions 111 and may not be assigned the image height 114. For example, as illustrated in FIG. 18, in a case where an image in which shading has occurred is input as the RAW image 75A into the trained model 106 generated by optimizing the model 98 by performing the machine learning on the model 98 using the example image 94 and the correct answer image 96 illustrated in FIG. 17, an image that is divided into the plurality of fourth image regions 124 and that is assigned the image height 122 for each fourth image region 124 is generated and output by the trained model 106 as the high image quality image 75A1. In this case, image quality adjustment corresponding to the image height 122 assigned for each fourth image region 124 is performed on each fourth image region 124 by performing the image quality adjustment processing on the high image quality image 75A1 via the processor 62. For example, the image quality adjustment corresponding to the image height 122 refers to image processing (so-called shading correction) of eliminating shading of the imaging lens 40 and/or shading on the light-receiving surface 72A. By doing so as in the examples illustrated in FIGS. 17 and 18, a decrease in image quality that occurs depending on the image height 122 in the high image quality image 75A1 (that is, shading of the imaging lens 40 and/or shading on the light-receiving surface 72A) can be suppressed.

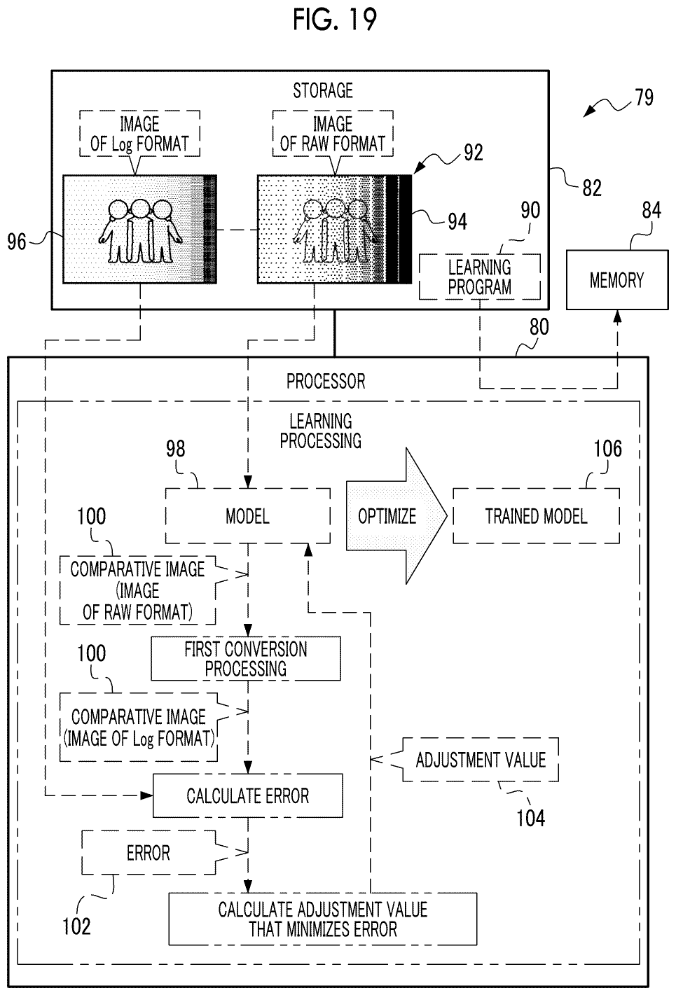

While an image of the RAW format is illustrated as the correct answer image 96 in the embodiment, the present disclosure is not limited to this. For example, as illustrated in FIG. 19, an image of the Log (logarithm) format may be used as the correct answer image 96. In this case, for example, an image of the RAW format is input into the model 98 as the example image 94, and an image of the RAW format is output from the model 98 as the comparative image 100. The learning processing includes first conversion processing. The first conversion processing is processing of converting the comparative image 100 from the image of the RAW format into an image of the Log format. The comparative image 100 obtained as the image of the Log format by performing the first conversion processing via the processor 80 is compared with the correct answer image 96, and the model 98 is optimized based on a comparison result.

The above configuration can reduce a load required for comparing the correct answer image 96 with the comparative image 100 compared to that for comparing the correct answer image 96 of the RAW format with the comparative image 100 of the RAW format, because the image of the Log format has a smaller data amount than the image of the RAW format. Posterization is likely to occur in the shadow portion because of insufficient bit accuracy. Thus, as illustrated in FIG. 19, by using the image of the RAW format as the example image 94 and using the image of the Log format having high accuracy of the shadow portion in an evaluation phase (that is, a phase in which the image output from the model 86 is compared with the correct answer image 96), the trained model 106 that generates and outputs an image in which a gradation of the shadow portion is corrected with high accuracy from the input image of the RAW format can be generated.

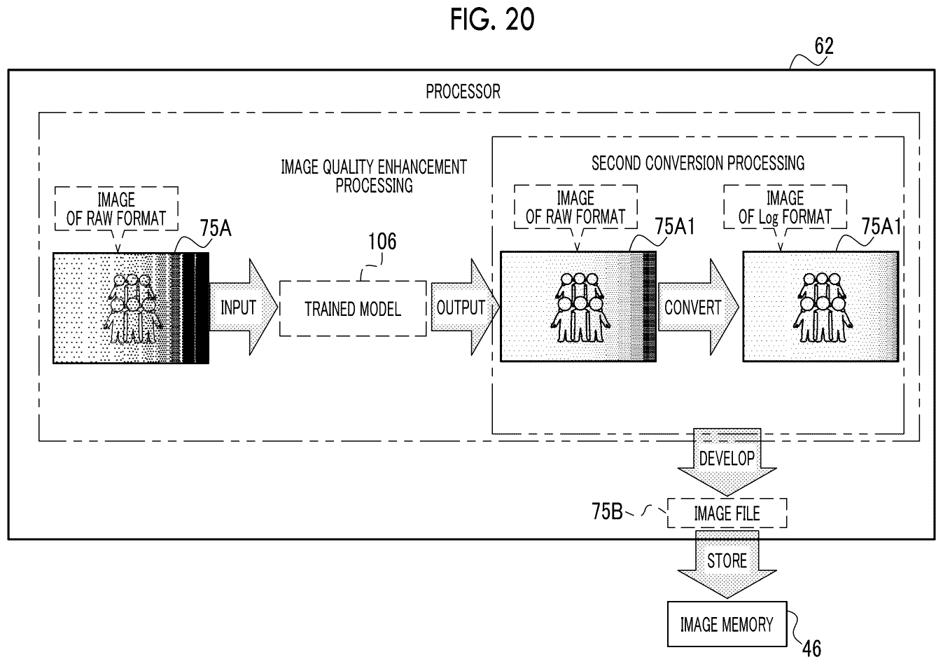

For example, as illustrated in FIG. 20, the image quality enhancement processing includes second conversion processing. Like the first conversion processing, the second conversion processing is processing of converting an image of the RAW format into an image of the Log format. In a case where the RAW image 75A is input into the trained model 106 optimized in the manner illustrated in FIG. 19, the trained model 106 generates and outputs the high image quality image 75A1 of the RAW format. The high image quality image 75A1 of the RAW format is converted into the high image quality image 75A1 of the Log format by executing the second conversion processing via the processor 62. The high image quality image 75A1 of the Log format is converted into a file in the same manner as the embodiment, and the image file 75B obtained by converting the high image quality image 75A1 into a file is stored in the image memory 46.

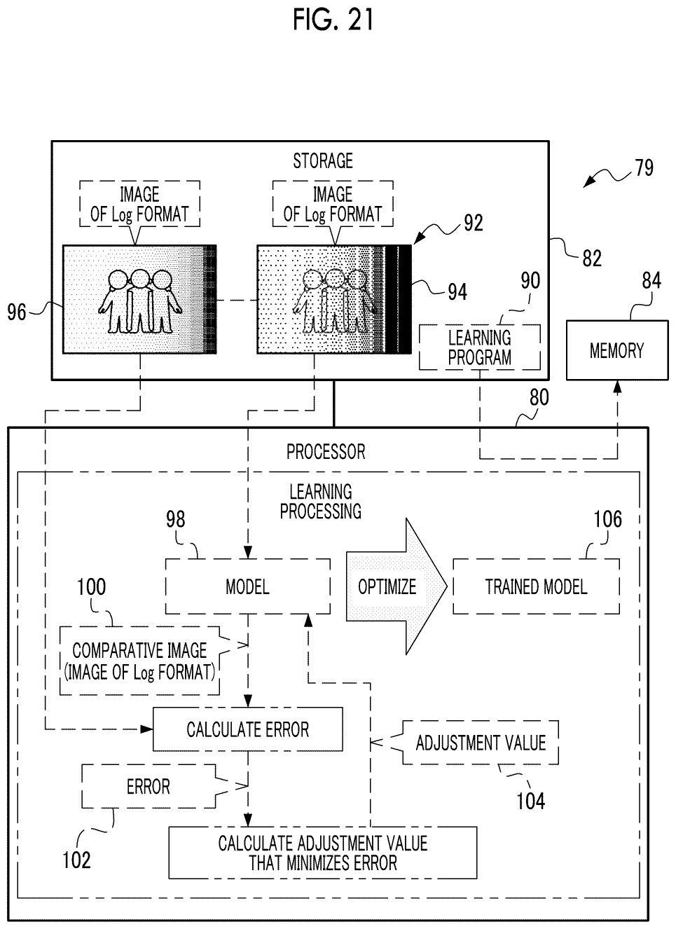

While an image of the RAW format is illustrated as the example image 94 in the example illustrated in FIG. 19, the present disclosure is not limited to this. For example, as illustrated in FIG. 21, the example image 94 may be an image of the Log format. In this case, the correct answer image 96 is also an image of the Log format. The Log format is an example of a “first file format” and a “second file format” according to the present disclosure. An image of the Log format is input into the model 98 as the example image 94, and an image of the Log format is output from the model 98 as the comparative image 100. Then, in the same manner as the embodiment, the comparative image 100 and the correct answer image 96 are compared with each other, and the model 98 is optimized based on the comparison result. Doing so can reduce the load required for comparing the correct answer image 96 with the comparative image 100 compared to that for comparing the correct answer image 96 of the RAW format with the comparative image 100 of the RAW format, because the image of the Log format has a smaller data amount than the image of the RAW format.

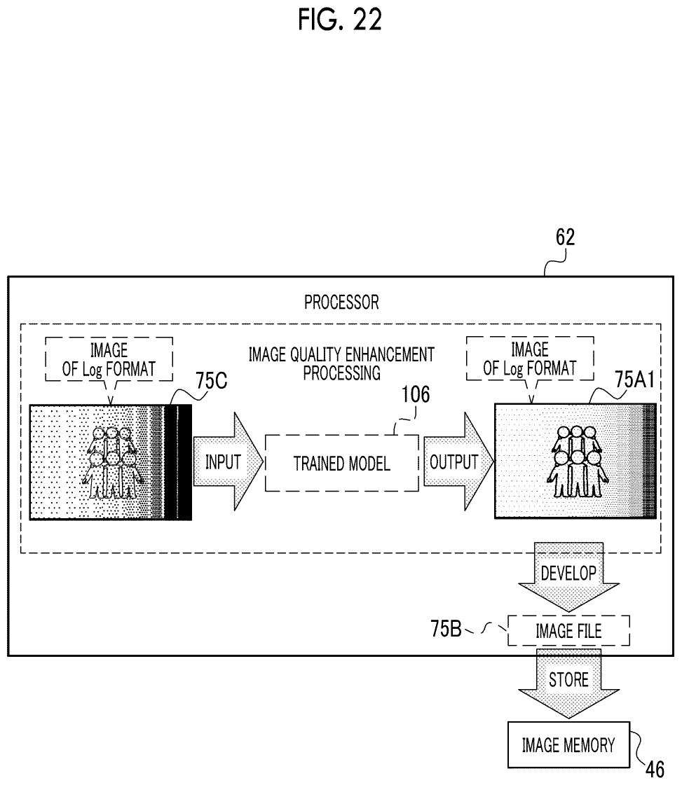

For example, as illustrated in FIG. 22, in a case where a Log image 75C obtained by converting the RAW image 75A into the Log format is input into the trained model 106 generated in the manner illustrated in FIG. 21, the trained model 106 generates and outputs the high image quality image 75A1 of the Log format. The high image quality image 75A1 of the Log format is converted into a file in the same manner as the embodiment, and the image file 75B obtained by converting the high image quality image 75A1 into a file is stored in the image memory 46.

In the image quality enhancement processing, by using the trained model 106 generated in the manner illustrated in FIG. 21, the same image quality enhancement as the embodiment can be implemented using the image of the Log format having a smaller data amount than the image of the RAW format even in a case where the imaging apparatus 10 is a model that does not support an image of the RAW format (for example, a model that does not support an image of the RAW format because the image of the RAW format has a large data amount and thus, restricts a transmission speed). In a case where a restriction on the transmission speed is imposed in the imaging apparatus 10 because of the data amount of the image, an image of a YC format after Log conversion or gamma conversion may be used. In this case, the image of the YC format may be used for the learning processing instead of the image of the Log format.

While various images (for example, the example image 94 and the correct answer image 96) in which the R pixels, the G pixels, and the B pixels are regularly disposed are illustrated in the embodiment, the various images may be monochromic images (for example, an R image consisting of only a plurality of R images, a G image consisting of only a plurality of G images, or a B image consisting of only a plurality of B images).

While an example of a form in which the processor 62 of the image processing engine 12 included in the imaging apparatus 10 performs the image quality enhancement processing has been illustratively described in the embodiment, the present disclosure is not limited to this. For example, a device that performs the image quality enhancement processing may be a device such as a server provided outside the imaging apparatus 10. For example, the server may be implemented by cloud computing. The server may be implemented by network computing such as fog computing, edge computing, or grid computing. While a server is illustrated, this is merely an example. At least one personal computer or the like may be used instead of the server.

While an example of a form in which the image quality enhancement program 107 is stored in the storage 64 has been illustratively described in the embodiment, the present disclosure is not limited to this. For example, the image quality enhancement program 107 may be stored in a portable computer-readable non-transitory storage medium such as an SSD or a USB memory. The image quality enhancement program 107 stored in the non-transitory storage medium is installed on the image processing engine 12 of the imaging apparatus 10. The processor 62 executes the image quality enhancement processing in accordance with the image quality enhancement program 107.

The image quality enhancement program 107 may be stored in a storage device of another computer, a server apparatus, or the like connected to the imaging apparatus 10 through a network, and the image quality enhancement program 107 may be downloaded in response to a request of the imaging apparatus 10 and installed on the image processing engine 12.

The storage device of another computer, a server apparatus, or the like connected to the imaging apparatus 10 or the storage 64 does not necessarily store the entire image quality enhancement program 107 and may store a part of the image quality enhancement program 107. While the image quality enhancement program 107 is mentioned, the same applies to the learning program 90.

While the image processing engine 12, is incorporated in the imaging apparatus 10 illustrated in FIGS. 1 and 2, the present disclosure is not limited to this. For example, the image processing engine 12 may be provided outside the imaging apparatus 10.

While the image processing engine 12 is illustrated in the embodiment, the present disclosure is not limited to this. A device including an ASIC, an FPGA, and/or a PLD may be applied instead of the image processing engine 12. A combination of a hardware configuration and a software configuration may also be used instead of the image processing engine 12.

Various processors illustrated below can be used as a hardware resource for executing the image quality enhancement processing and/or the learning processing described in the embodiment. Examples of the processor include a CPU that is a general-purpose processor functioning as the hardware resource for executing the image quality enhancement processing and/or the learning processing by executing software, that is, a program. Examples of the processor also include a dedicated electric circuit such as an FPGA, a PLD, or an ASIC that is a processor having a circuit configuration dedicatedly designed to execute specific processing. A memory is incorporated in or connected to any of the processors, and any of the processors executes the image quality enhancement processing and/or the learning processing using the memory.

The hardware resource for executing the image quality enhancement processing and/or the learning processing may be composed of one of the various processors or be composed of a combination of two or more processors of the same type or different types (for example, a combination of a plurality of FPGAs or a combination of a CPU and an FPGA). The hardware resource for executing the image quality enhancement processing and/or the learning processing may also be one processor.

Examples of the hardware resource composed of one processor include, first, a form of one processor composed of a combination of one or more CPUs and software, in which the processor functions as the hardware resource for executing the image quality enhancement processing and/or the learning processing. Second, as represented by an SoC or the like, a form of using a processor that implements functions of the entire system including a plurality of hardware resources for executing the image quality enhancement processing and/or the learning processing in one IC chip is included. As described above, the image quality enhancement processing and/or the learning processing are implemented using one or more of the various processors as the hardware resource.

More specifically, an electric circuit in which circuit elements such as semiconductor elements are combined can be used as a hardware structure of the various processors. The image quality enhancement processing and/or the learning processing is merely an example. Accordingly, it is possible to delete an unnecessary step, add a new step, or change a processing order without departing from the gist of the present disclosure.

Above described content and illustrated content are detailed description for parts according to the present disclosure and are merely an example of the present disclosure. For example, description related to the above configurations, functions, actions, and effects is description related to examples of configurations, functions, actions, and effects of the parts according to the present disclosure. Thus, it is possible to remove an unnecessary part, add a new element, or replace a part in the above described content and the illustrated content without departing from the gist of the present disclosure. Particularly, description related to common technical knowledge or the like that is not required to be described for embodying the present disclosure is omitted in the above described content and the illustrated content in order to avoid complication and facilitate understanding of the parts according to the present disclosure.

All documents, patent applications, and technical standards disclosed in the present specification are incorporated in the present specification by reference to the same extent as those in a case where each of the documents, patent applications, and technical standards are specifically and individually indicated to be incorporated by reference.

The following appendixes are further disclosed with respect to the above embodiment.

### Appendix 1

Training data used for machine learning of a model, the training data comprising a correct answer image, and an example image having a smaller bit depth than the correct answer image.

### Appendix 2

The training data according to Appendix 1, in which the example image is an image obtained by decreasing the bit depth of the correct answer image by performing bit shifting of the correct answer image.

### Appendix 3

The training data according to Appendix 1, in which the correct answer image is an image obtained by adding a plurality of single images.

### Appendix 4

The training data according to Appendix 1, in which the correct answer image is an image obtained by calculating an arithmetic mean of a plurality of single images.

### Appendix 5

The training data according to Appendix 1, in which the example image is a representative image of a plurality of single images, and the representative image is at least one image among the plurality of single images or an image generated based on at least one of the plurality of single images.

### Appendix 6

The training data according to Appendix 1, in which the correct answer image is an image obtained by calculating an arithmetic mean of a processing target region in an image subjected to bit shifting and at least one region adjacent to the processing target region.

### Appendix 7

The training data according to Appendix 1, in which the correct answer image is divided into a plurality of image regions.

### Appendix 8

The training data according to Appendix 7, in which the correct answer image is an image obtained by performing imaging via an imaging apparatus including an optical system, and an image height related to the optical system is assigned to each of the plurality of image regions.

### Appendix 9

A trained model obtained by optimizing the model by performing the machine learning on the model using the training data according to any one of Appendixes 1 to 8.

### Appendix 10

A program (for example, the image quality enhancement program 107) causing a computer (for example, the image processing engine 12) to execute image quality enhancement processing comprising inputting a captured image obtained by performing imaging via an image sensor into the trained model according to Appendix 9, and acquiring an inference result output from the trained model in accordance with input of the captured image.

### Appendix 11

A program (for example, the learning program 90) causing a computer (for example, the learning device 79) to execute learning processing of generating a trained model by performing machine learning on a model using training data including a correct answer image and an example image, the example image being an image having a smaller bit depth than the correct answer image, the learning processing comprising inputting the example image into the model, outputting an evaluation target image (for example, the comparative image 100) in accordance with input of the example image via the model, and optimizing the model based on a comparison result between the evaluation target image and the correct answer image.

### Appendix 12

A computer-readable non-transitory storage medium storing a program (for example, the image quality enhancement program 107) causing a computer (for example, the image processing engine 12) to execute image quality enhancement processing comprising inputting a captured image obtained by performing imaging via an image sensor into the trained model according to Appendix 9, and acquiring an inference result output from the trained model in accordance with input of the captured image.

### Appendix 13

A computer-readable non-transitory storage medium storing a program (for example, the learning program 90) causing a computer (for example, the learning device 79) to execute learning processing of generating a trained model by performing machine learning on a model using training data including a correct answer image and an example image, the example image being an image having a smaller bit depth than the correct answer image, the learning processing comprising inputting the example image into the model, outputting an evaluation target image (for example, the comparative image 100) in accordance with input of the example image via the model, and optimizing the model based on a comparison result between the evaluation target image and the correct answer image.

What is claimed is:

1. Training data used for machine learning of a model, the training data comprising:
a correct answer image; and
an example image having a smaller bit depth than the correct answer image.

2. The training data according to claim 1,
wherein the correct answer image is an image obtained by combining a plurality of single images.

3. The training data according to claim 2,
wherein the example image is a representative image of the plurality of single images.

4. The training data according to claim 2,
wherein the example image is an image having a smaller bit depth than the plurality of single images.

5. The training data according to claim 2,
wherein the single images are images subjected to bit shifting.

6. The training data according to claim 1,
wherein the correct answer image is
an image obtained by combining a processing target region in an image subjected to bit shifting with a corresponding region in which an arrangement pattern in the image corresponds to the processing target region, in a case where the corresponding region is present in the image, or
an image obtained by combining a processing target pixel in an image subjected to bit shifting with an adjacent pixel that has the same color as the processing target pixel and that is regularly adjacent to the processing target pixel, in a case where the adjacent pixel is present in the image.

7. The training data according to claim 6,
wherein the example image is an image before bit shifting or an image generated based on an image before bit shifting.

8. The training data according to claim 1,
wherein the correct answer image and the example image are images obtained by performing imaging via a first imaging apparatus.

9. The training data according to claim 1,
wherein the correct answer image and the example image are images of a RAW format.

10. The training data according to claim 1, wherein the model takes input of an image of a RAW format and outputs an image of the RAW format,
a format of the correct answer image is a Log format, and
the model is optimized by converting the image of the RAW format output from the model into an image of the Log format and comparing the image of the Log format with the correct answer image.

11. The training data according to claim 1,
wherein the model outputs an image of a second file format other than a RAW format with respect to input of an image of a first file format other than the RAW format,
a format of the example image is the first file format, and
a format of the correct answer image is the second file format.

12. The training data according to claim 1,
wherein the example image is divided into a plurality of first image regions, and the correct answer image is divided into a plurality of second image regions corresponding to the plurality of first image regions.

13. The training data according to claim 12,
wherein a label with which image quality is specifiable is assigned to the plurality of second image regions.

14. The training data according to claim 13,
wherein the example image is an image assuming an image obtained by performing imaging via a second imaging apparatus, and
the image quality is determined by a characteristic of the second imaging apparatus.

15. The training data according to claim 14,
wherein the second imaging apparatus includes an optical system, and the characteristic includes an image height related to the optical system.

16. A trained model obtained by optimizing the model by performing the machine learning on the model using the training data according to claim 1.

17. An imaging apparatus comprising:
a first processor; and
an image sensor,
wherein the first processor is configured to:
input a captured image obtained by performing imaging via the image sensor into the trained model according to claim 16; and
acquire an inference result output from the trained model in accordance with input of the captured image.

18. A learning device comprising:
a second processor,
wherein the second processor is configured to optimize the model by performing the machine learning on the model using the training data according to claim 1.

19. A method of creating training data used for machine learning of a model,
the training data including a correct answer image and an example image,
the method comprising:
creating the correct answer image; and
creating the example image having a smaller bit depth than the correct answer image.

20. A method of generating a trained model that is generated by performing machine learning on a model using training data including a correct answer image and an example image,
the example image being an image having a smaller bit depth than the correct answer image,
the method comprising:
inputting the example image into the model;
outputting an evaluation target image in accordance with input of the example image via the model; and
optimizing the model based on a comparison result between the evaluation target image and the correct answer image.
